(19) United States
(12) Patent Application Publication
(10) Pub. No.: US 2024/0010805 A1
(43) Pub. Date: Jan. 11, 2024

(54) BMI RESIN FORMULATION FOR CARBON FIBER REINFORCED COMPOSITE MATERIAL, METHOD FOR MAKING IT AND BMI PREPREG

(71) Applicant: Toray Composite Materials America, Inc., Tacoma, WA (US)

(72) Inventors: Madelyn Milligan, Tacoma, WA (US); Jonathan C. Hughes, Tacoma, WA (US); Alfred P. Haro, Tacoma, WA (US); Toshiya Kamae, Tacoma, WA (US); Naoki Matsuura, Tacoma, WA (US); Koji Furukawa, Tacoma, WA (US)

(73) Assignee: Toray Composite Materials America, Inc., Tacoma, WA (US)

(21) Appl. No.: 18/039,859

(22) PCT Filed: Dec. 2, 2021
(86) PCT No.: PCT/US2021/061612

§ 371 Date: Jun. 1, 2023

Related U.S. Application Data
(60) Provisional application No. 63/121,632, filed on Dec. 4, 2020.

(51) Int. Cl. C08J 5/24

(52) U.S. Cl. CPC C08J 5/243; C08J 5/249; C08J 2379/08

(57) ABSTRACT

A fiber reinforced prepreg comprising reinforcement fibers; particles (D1) and (D2); and a thermosetting resin composition is provided. The resin includes maleimide compound (A), and co-monomer (B). Co-monomer (B) has least one of an alkenylphenol, an alkenylphenoxy, or a diamine group. Particles (D1) are smaller than (D2) and particles (D1) and (D2) are insoluble in the thermosetting resin. Particles (D1) range in diameter from 1 to 10 microns and have a mode on a volume basis from 3 to 6 microns and are present from 3 to 12 percent by volume of the thermosetting resin. Particles (D2) range from 10 to 100 microns diameter and a mode of 20 to 60 microns and are present from 1 to 6 percent by volume of the thermosetting resin composition. After cure, at least 90% by volume of particles (D1) and (D2) remain in the prepreg interlayers.

### CROSS-REFERENCE TO RELATED APPLICATION

This application claims priority to U.S. Provisional Application No. 63/121,632, filed Dec. 4, 2020, titled BMI RESIN FORMULATION FOR CARBON FIBER REINFORCED COMPOSITE MATERIAL, BMI PREPREG AND CARBON FIBER REINFORCED COMPOSITE MATERIAL, incorporated herein by reference.

### TECHNICAL FIELD

The present invention relates to a fiber reinforced prepreg for producing fiber reinforced composite parts for applications requiring high temperature resistance and excellent compression strength after impact properties.

### BACKGROUND

A deficiency of current maleimide and bismaleimide (BMI) resins as well as benzoxazine (BOX) resins for the matrix of carbon fiber reinforced composite materials is reduced fracture toughness, as measured by compression after impact (CAI) of the composite part. Techniques for increasing the fracture toughness, such as dissolving thermoplastics into the matrix resin are not very effective since only a few thermoplastics dissolve into the BMI resin matrix. For example, typical polyimides (PI), tend to have a very high molecular weight so only small amounts can be dissolved into the BMI resin without causing an undesirable increase in viscosity at room temperature. This high viscosity reduces the tack of the prepreg, leading to a brittle prepreg. Other lower molecular weight thermoplastics, such as amine terminated polyethersulfone (PES), require high loading amounts in the thermosetting resin composition to have any effect on the toughness of the BMI or BOX matrices. These high amounts of PES start to degrade the overall properties of the BMI or BOX matrix, thus the resulting prepreg and composite structures do not have the desirable mechanical and thermal advantages that the BMI and benzoxazine resins are known for.

Another method that has been attempted to increase the toughness of carbon fiber composites is to apply particles to the interlayer between the plies of the prepreg. Traditional particulate interlayer tougheners such as polyamides cannot withstand the high use temperatures of BOX or BMI, let alone the even higher necessary cure temperatures. Currently, particles having a Tg greater than 200° C. can be used to increase the toughness but are only marginally successful due to their low toughness. These particles are difficult to dissolve into solvents as well, making it difficult to create the highly spherical particles which are normally advantageous for good toughening particles. Since the particles can only be made sufficiently small by grinding methods, these particles have irregular shapes, thus further reducing their effectiveness to increase the toughness of higher temperature matrix materials such as BMI, polyimide, BOX and certain high temperature epoxies.

PI particles have been used in the past to toughen BMI carbon fiber reinforced prepreg (CFRP) systems. The high amounts of PI particles needed to increase the toughness reduce the overall usage of the material, due to economic and mechanical property issues. When the volume of particles incorporated into the prepreg is high, the ease of handling and tack of these prepregs is compromised, making it difficult to process the prepreg into parts. Furthermore, if the volume of particles is too high, it is difficult to improve the flow characteristics of the resin system in the prepreg.

The present inventors have intensively studied the above problems and have discovered that they can be solved by preparing a fiber-reinforced prepreg incorporating a bismaleimide or BOX resin composition as the matrix, and interlaminar particles that include two different sized particles.

### SUMMARY

A fiber reinforced prepreg comprising reinforcement fibers and a thermosetting resin composition. The thermosetting resin composition comprises, consists of or consists essentially of a first co-monomer (A), a second co-monomer (B), and particles (D). The particles (D) are insoluble in the first co-monomer (A) and the second co-monomer (B). The particles (D) comprise, consist of or consist essentially of from 4 to 18 percent by volume of the total thermosetting resin composition in the prepreg and have a range of particle diameters from 1 to 100 microns and at least one mode on a volume basis from 3 to 60 microns. A cured composite made from the fiber reinforced prepreg has a compressive strength after impact (CAI) of 35 ksi or more measured according to ASTM standard ASTM D7137M-17, as set forth in detail in the Examples herein, after being impacted at 4.45 kJ/m when at least one of the following conditions i) or ii) is met.
i) the first co-monomer (A) comprises, consists of, or consists essentially of a maleimide compound and the second co-monomer (B) comprises, consists of or consists essentially of at least one of an alkenylphenol group, an alkenylphenoxy group, or a diamine group; or
ii) the particles (D) comprise, consist of, or consist essentially of particles (D1) and (D2) and the particles (D1) comprise, consist of, or consist essentially of from 3 to 12 percent by volume of the total thermosetting resin composition in the prepreg and have a range of particle diameters from 1 to 10 microns and a mode on a volume basis from 3 to 6 microns; and the particles (D2) comprise, consist of or consist essentially of from 1 to 6 percent by volume of the total thermosetting resin composition in the prepreg and have a range of particle diameters from 10 to 100 microns and a mode on a volume basis from 20 to 60 microns.

A thermosetting resin composition is provided as well. The thermosetting resin composition comprises, consists of, or consists essentially of a first co-monomer (A), a second co-monomer (B), and particles (D). The particles (D) are insoluble in the first co-monomer (A) and the second co-monomer (B). The particles (D) comprise, consist of, or consist essentially of from 4 to 18 percent by volume of the total thermosetting resin composition in the prepreg and have a range of particle diameters from 1 to 100 microns and at least one mode on a volume basis from 3 to 60 microns. At least one of the following conditions i) or ii) is met.
i) the first co-monomer (A) comprises a maleimide compound and the second co-monomer (B) comprises at least one of an alkenylphenol group, or an alkenylphenoxy group, or a diamine group; or
ii) the particles (D) comprises particles (D1) and (D2) and the particles (D1) have a range of particle diameters from 1 to 10 microns and a mode on a volume basis from 3 to 6 microns, and the particles (D1) comprise from 3 to 12 percent by volume of the total thermosetting resin composition; and the particles (D2) have a range of particle diameters from 10 to 100 microns and a mode on a volume basis from 20 to 60 microns and the particles (D2) comprise from 1 to 6 percent by volume of the total thermosetting resin composition.

A method of making a thermosetting resin composition is also provided. The method comprises, consists of, or consists essentially of a step of combining the following:
a first co-monomer (A),
a second co-monomer (B),
particles (D1), and
particles (D2).

The particles (D1) and (D2) are insoluble in the first co-monomer (A) and the second co-monomer (B). The particles (D1) have a range of particle diameters from 1 to 10 microns and a mode on a volume basis from 3 to 6 microns, and the particles (D1) comprise from 3 to 12 percent by volume of the total thermosetting resin composition. The particles (D2) have a range of particle diameters from 10 to 100 microns and a mode on a volume basis from 20 to 60 microns and the particles (D2) comprise from 1 to 6 percent by volume of the total thermosetting resin composition.

Cured composite materials made from these fiber reinforced prepregs exhibit excellent compression after impact, as well as other desirable properties that are described herein.

### BRIEF DESCRIPTION OF THE DRAWINGS

FIG. 1 shows an example of typical frequency distributions of particles (D1) and (D2), plotted as a function of volume percent of particle diameters;

FIG. 2 shows the effect of CAI of varying levels of two different particle sizes; and

FIG. 3 shows a cross section of a cured laminate showing the fiber layer and the interlayer containing particles.

### DETAILED DESCRIPTION OF EMBODIMENTS OF THE INVENTION

The inventors have found that the CAI of cured fiber reinforced composite (FRC) parts is improved when a population of particles (D) is included in a resin composition comprising a first co-monomer (A) and a second co-monomer (B). The population of particles (D) are insoluble in the first co-monomer (A) and the second co-monomer (B) and the particles (D) comprise, consist of, or consist essentially of from 4 to 18 percent by volume of the total thermosetting resin composition in the prepreg and have a range of particle diameters from 1 to 100 microns and at least one mode on a volume basis from 3 to 60 microns. In order to effect the improvement in CAI of the cured composite, at least one of the following two conditions is met. These conditions are:
i) The co-monomer (A) comprises, consists of, or consists essentially of a maleimide compound and the second co-monomer (B) comprises, consists of, or consists essentially of at least one of an alkenylphenol group, or an alkenylphenoxy group, or a diamine group.
ii) The particles (D) comprise, consist of, or consist essentially of two populations of particles, (D1) and (D2). Each population of particles, (D1) and (D2) has its own range of particle diameter and its own mode on a volume basis within each respective distribution. The particles (D1) have a range of particle diameters from 1 to microns and a mode on a volume basis from 3 to 6 microns. The particles (D1) comprise from 3 to 12 percent by volume of the total thermosetting resin composition; and the particles (D2) have a range of particle diameters from 10 to 100 microns and a mode on a volume basis from 20 to 60 microns and the particles (D2) comprise from 1 to 6 percent by volume of the total thermosetting resin composition.

The CAI values referred to herein are measured on cured fiber reinforced composites made and cured according to the procedures and using the carbon fibers described in the Examples and the measurement is carried out according to standard ASTM D 7137M-17 after being impacted at 4.45 kJ/m.

As used herein, the mode is the most common particle diameter within each range of particles sizes on a volume basis. As used herein, the term volume percent by total thermosetting resin composition, or volume % by total thermosetting resin composition means volume percent including the thermosetting resin and any other additives, including the particles (D), which may comprise particles (D1) and (D2), but not including the fibers in the prepreg or composite.

The matrix of these prepregs is a thermosetting resin composition. According to an embodiment, the thermosetting composition may include a first co-monomer (A) comprising, consisting of, or consisting essentially of maleimide or bismaleimide compound and a second co-monomer (B). According to certain embodiments, the maleimide compound of first co-monomer (A) may include at least one of N,N′-4,4′-diphenylmethane-bis-maleimide, N,N′-2,4-toluene-bis-maleimide, N,N′-2,2,4-trimethylhexane-bis-maleimide, or mixtures thereof. According to certain embodiments, the first co-monomer maleimide compound (A) may be a eutectic mixture of two or more bismaleimide compounds. As used herein the term “eutectic” means that the melting point of the mixture is at a minimum and is less than the melting point of the individual bismaleimide compounds. The co-monomer (B) may include at least one of an alkenylphenol group, an alkenylphenoxy group, or a diamine group. According to certain embodiments, the co-monomer (B) may be o,o′-diallylbisphenol A.

The particles (D), which may comprise, consist of, or consist essentially of particles (D1) and particles (D2) are insoluble in the first co-monomer (A) and the second co-monomer (B). The particles (D) may comprise, consist of, or consist essentially of from 4 to 18 percent by volume of the total thermosetting resin composition in the prepreg and have a range of particle diameters from 1 to 100 microns and at least one mode on a volume basis from 3 to 60 microns. The particles (D1) may be present in the prepreg at from 3 to 12 percent by volume of the total thermosetting resin composition in the prepreg. The particles (D1) may have a range of particle diameters from 1 to 10 microns and a mode from 3 to 6 microns, on a volume basis. The particles (D2) may be present in the prepreg at from 1 to 6 percent by volume of the total thermosetting resin composition. The particles (D2) may have a range of particle diameters from 10 to 100 microns and a mode of 20 to 60 microns on a volume basis. According to another embodiment, the particles (D2) may have a range of particle diameters of from 20 to 60 microns and a mode of 20 to 50 microns on a volume basis.

As mentioned above, the fiber reinforced prepreg may have at least two layers, designated as a fiber layer and an interlayer. The fiber layer includes the reinforcement fibers impregnated with the thermosetting resin composition of maleimide component (A) and co-monomer (B), but in an embodiment, the fiber layer preferably includes no or very little of the particles (D) which may include particles (D1) and particles (D2). The interlayer includes the thermosetting resin composition and the particles (D) which may include particles (D1) and (D2), but does not include (or includes very little) of the reinforcing fibers, as is known in the art. In an embodiment, at least 90% by volume of the total amount of particles (D), which may comprise particles (D1) and particles (D2). remain in the interlayer after cure of the prepreg.

In an embodiment, the particles (D) include polyimide particles. In an embodiment, the particles (D1) include polyimide particles. In an embodiment, the particles (D2) include polyimide particles. According to an embodiment, the particles (D) may have a glass transition temperature of 200° C. or higher. In yet another embodiment, the particles (D) may have a glass transition temperature of 220° C. or higher. According to an embodiment, the particles (D1) may have a glass transition temperature of 200° C. or higher. In yet another embodiment, the particles (D1) may have a glass transition temperature of 220° C. or higher. In an embodiment, the particles (D2) may have a glass transition temperature of 200° C. or higher. In yet another embodiment, the particles (D1) may have a glass transition temperature of 220° C. or higher.

According to an embodiment, the thermosetting resin composition may further include a thermoplastic (C) dissolved therein. The particles (D), which may include particles (D1) and particles (D2), are not soluble in this thermoplastic (C). In an embodiment, the thermoplastic (C) may be polyimide and may be present in an amount of from 0.5 to 5% by weight of the total thermosetting resin composition, exclusive of the particles (D), which may include particles (D1) and (D2).

The thermosetting resin composition may further include an accelerator, also referred to herein as a catalyst, in an amount sufficient to reduce the resin flow index at 40° C. of the thermosetting resin composition to 5 or less. According to an embodiment, the amount of accelerator may be from 0.05 to 0.5% by weight of components (A) and (B). In another embodiment, the accelerator may be a phosphorous containing accelerator. The thermoplastic (C) serves to reduce tack of the prepreg, which affects its ease of handling. However, the presence of the thermoplastic decreases the viscosity of the thermosetting resin composition during cure, before it is sufficiently cured. Thus, during cure, the thermosetting resin may undesirably move and flow. The accelerator thus serves to increase the cure rate of the thermosetting resin composition, increasing its viscosity and mitigating the unwanted flow and movement of the thermosetting resin during the cure cycle.

The invention also provides a fiber reinforced composite article or part or material obtained by curing the fiber reinforced prepreg disclosed herein. Also provided is a method of making a fiber-reinforced composite material or article or part, the method being curing the fiber reinforced prepreg at a temperature of from 180° C. to 300° C.

The invention also provides a thermosetting resin composition. The thermosetting resin composition comprises, consists of, or consists essentially of a first co-monomer (A), a second co-monomer (B), and particles (D). The particles (D) are insoluble in the first co-monomer (A) and the second co-monomer (B) and the particles (D) comprise from 4 to 18 percent by volume of the total thermosetting resin composition in the prepreg and have a range of particle diameters from 1 to 100 microns and at least one mode on a volume basis from 3 to 60 microns. At least one or both of the following conditions i) or ii) is met.
i) The first co-monomer (A) comprises, consists of, or consists essentially of a maleimide compound and the second co-monomer (B) comprises, consists of, or consists essentially at least one of an alkenylphenol group, or an alkenylphenoxy group, or a diamine group.
ii) The particles (D) comprise, consist of, or consist essentially of particles (D1) and (D2) and the particles (D1) have a range of particle diameters from 1 to 10 microns and a mode on a volume basis from 3 to 6 microns, and the particles (D1) comprise from 3 to 12 percent by volume of the total thermosetting resin composition; and the particles (D2) have a range of particle diameters from 10 to 100 microns and a mode on a volume basis from 20 to 60 microns; and the particles (D2) comprise from 1 to 6 percent by volume of the total thermosetting resin composition.

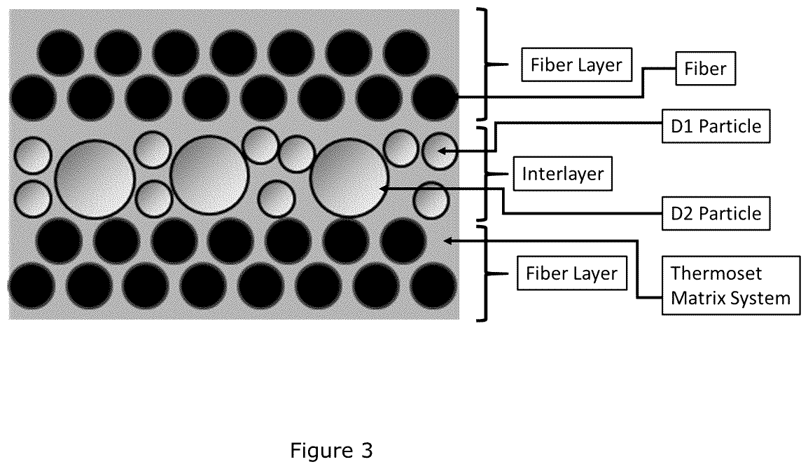

The fiber reinforced prepreg may have a fiber layer and an interlayer. The interlayer is the layer of resin in between the fiber layers and contains the particles (D), which may comprise particles (D1) and (D2) as shown in FIG. 3. As is known in the art, the intralayer of resin is the resin in between the fibers in the fiber layer. The fiber reinforced prepreg may be produced by either of two methods.

In the first method, the prepreg may be formed by impregnating one or both sides of a fiber layer such as a fiber tow, mesh, fabric, or bundle with a single film containing the thermosetting resin composition, particles (D), which may include particles (D1) and particles (D2). In this method, the fibers may serve to “filter” the particles (D) from entering into the intralayers of resin between the fibers of the fiber layer during the impregnation process. Thus, according to this method, 90% or greater by volume of all particles (D) stay within the interlayer, rather than being in the intralayers of the fiber layer, after impregnation and after cure.

In the second method, the prepreg may be formed by first impregnating one or both sides of a fiber layer such as a fiber tow, mesh, fabric, or bundle, with a first layer of resin film that includes the thermosetting resin composition but does not include particles (D). The next step of this second method is to place a second layer of resin film including the thermosetting resin, and particles (D), which may include particles (D1) and (D2) on one or both sides of the first layer of resin film. Thus, in certain embodiments, the interlayer may be formed by placing the thermosetting resin containing particles (D) on the fiber layer to make sure that 90% or greater by volume of all particles (D), which may include particles (D1) and (D2), stay within the interlayer after cure. This means that 10% or less by volume of the particles (D) are in the intralayer between the fibers in the fiber layer after cure.

The fiber reinforced prepreg, as a cured composite, may have a CAI (Compression After Impact) value of 35 ksi or greater. In certain embodiments, 60%, 65%, 70%, 75%, 80%, 85%, 90%, 95% or more, of the particles (D) by volume remain in the interlayer after cure of the prepreg. The particles (D) comprise from 4 to 18 percent by volume of the total thermosetting resin composition in the prepreg and have a range of particle diameters from 1 to 100 microns and at least one mode on a volume basis from 3 to 60 microns. The CAI of the cured prepreg may be from 35, 37.5, 40, 42.5, 45, 47.5, or 50 ksi or more, according to certain embodiments.

The CAI of 35 ksi or more may be achieved by the inclusion of particles (D) that comprise, consist of, or consist essentially of particles (D1) and (D2) and the particles (D1) have a range of particle diameters from 1 to 10 microns and a mode on a volume basis from 3 to 6 microns, and the particles (D1) comprise from 3 to 12 percent by volume of the total thermosetting resin composition; and the particles (D2) have a range of particle diameters from 10 to 100 microns and a mode on a volume basis from to 60 microns and the particles (D2) comprise from 1 to 6 percent by volume of the total thermosetting resin composition that include a first co-monomer (A) and a second co-monomer (B). In this embodiment, the first and second co-monomers are not particularly limited.

According to another embodiment, the fiber reinforced prepreg, as a cured composite, may have a CAI (Compression After Impact) value of 35, 37.5, 40, 42.5, 45, 47.5, or 50 ksi or greater. In this embodiment the particles (D) comprise from 4 to 18 percent by volume of the total thermosetting resin composition in the prepreg and have a range of particle diameters from 1 to 100 microns and at least one mode on a volume basis from 3 to 60 microns and the first co-monomer (A) comprises a maleimide compound and the second co-monomer (B) comprises at least one of an alkenylphenol group, or an alkenylphenoxy group, or a diamine group. According to another embodiment, the co-monomer (B) may comprise a vinyl group.

According to another embodiment, thermosetting resin composition in the fiber reinforced prepreg further comprises a thermoplastic (C).

The particles (D) may include one or more types of particles. For example, the particles (D) may be a blend of different populations of sizes (D1) and (D2). The particles (D) may be a blend of particles made from different materials. The particles (D1) may include particles made from one or more types of materials. The particles (D2) may include particles made from one or more types of materials. The volume ratio of smaller particles (D1) to larger particles (D2) may be from 90:10 to 50:50, or from to 60:40 or from 80:20 to 60:40, The volume ratio of (D1) to (D2) may be equal to or greater than 90:10, or 80:10, or 70:30, or 60:40, or equal to or greater than 50:50.

The fiber reinforced prepreg may have a fiber layer and an interlayer. The thermosetting resin composition not containing (or containing 10% or less by volume of the particles (D)) may be impregnated into the fiber layer containing the reinforcing fiber to provide the fiber layer. The thermosetting resin composition containing particles (D) may be placed on the fiber layer to provide the interlayer. In an embodiment, 90% or more of the particles (D) by total volume of the particles (D) may stay within the interlayer after cure.

The fiber reinforced prepreg including the thermosetting resin composition may have a CAI of 35 ksi or greater after cure. The CAI may be 35, 37.5, 40, 42.5, 45, 47.5, or 50 ksi or greater, according to certain embodiments. Some embodiments of the present invention may have CAI greater than 35 ksi where toughness is not particularly needed for the CFRP such that lower amounts (by volume) of particles can be used. Reducing the amount of particles by volume may also increase other properties such as compression type properties such as compression strength and OHC (Open Hole Compression). According to certain embodiments of the invention, cured composites made with the fiber reinforced prepreg, or thermosetting resin composition may have CAI of 50 ksi or greater. This property is important in applications where toughness is important to the CFRP part such that high impact resistance is needed, e.g., for the primary structure of aerospace parts.

In certain exemplary embodiments, a cured BMI (bismaleimide) matrix resin obtained by curing the abovementioned BMI resin is provided. Also provided, according to certain embodiments, is a prepreg obtained by impregnating reinforcing fibers with the abovementioned thermosetting resin composition and the particles (D), which may include particles (D1) and (D2), such that 90% or more by volume of the particles (D) remain in an interlayer of the prepreg after cure. Also provided is a fiber-reinforced composite material or part or article comprising a cured product obtained by curing a prepreg comprising the abovementioned BMI resin composition, including 90% or more by volume of the particles (D) (which may comprise particles (D1) and (D2)) in the interlayer, and a reinforcing fiber base. If 90% or more by volume of the particles (D) are contained within the interlayer after cure, then the particles (D) can effectively increase the toughness of the cured CFRP.

### Particles (D) and Particles (D1) and (D2)

The inventors have found that the CAI of a cured fiber reinforced composite (FRC) parts is improved when particle (D) having a particular range of sizes is included in the included in the interlayer between plies of fiber reinforced prepregs from which the cured parts are made. In particular, when the first co-monomer (A) comprises a maleimide compound and the second co-monomer (B) comprises at least one of an alkenylphenol group, or an alkenylphenoxy group, or a diamine group, particles (D) comprising from 4 to 18 percent by volume of the total thermosetting resin composition in the prepreg and having a range of particle diameters from 1 to 100 microns and at least one mode on a volume basis from 3 to 60 microns are effective to provide a cured composite having a CAI of 35 ksi or higher measured according to ASTM standard ASTM D 7137M-17 according to the procedures set forth in the Examples herein after being impacted at 4.45 Id/m. The (D) particles may have a range of particle diameters from 1 to 100 microns, from 10 to 90 microns, from 10 to 80 microns, 20 to 100 microns, from 10 to 70 microns, from 30 to 100 microns, from 5 to 95 microns, from to 95 microns, from 3 to 85 microns, from 4 to 60 microns, from 1 to 70 microns, or from 3 to 85 microns. The at least one mode of the particles (D) may be from 3 to 60 microns, from 5 to 55 microns, 10 to 50 microns, or from 15 to 45 microns.

According to some embodiments the particles (D) may comprises, consist of, or consist essentially of at least two populations of particles, referred to herein as (D1) and (D2).

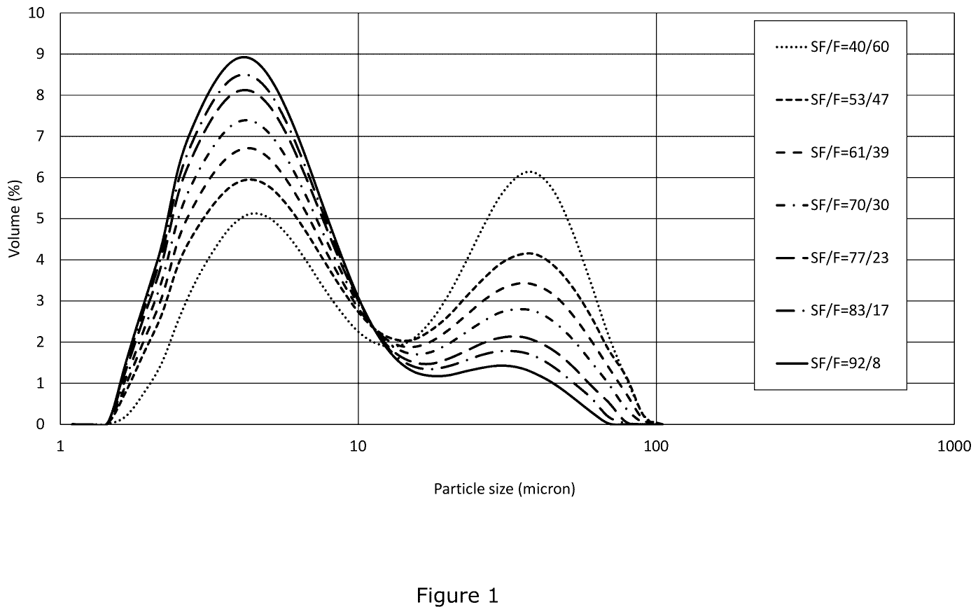

The inventors have found that the CAI of cured fiber reinforced composite (FRC) parts is improved when at least two sizes of particles, referred to herein as particles (D1) and particles (D2), are included in the interlayer between plies of fiber reinforced prepregs from which the cured parts are made. Thus, the interlayer of these prepregs includes these two populations of particles, (D1) and (D2). Each population of particles (D1) and (D2) has its own range of particle diameter and mode, on a volume basis. As used herein, the mode is the most common particle diameter within each range of particle sizes, when plotted as a frequency distribution by volume. FIG. 1 shows an example of a frequency distribution showing the mode by volume percent and ranges of diameter for particles (D1) and (D2). The mode of each of the particles (D1) and (D2) is the most frequent diameter by volume (i.e., the peak) within each range of particle diameter sizes. FIG. 1 shows a number of plots of different volume ratios of smaller particles (D1) to larger particles (D2). As seen in FIG. 1, the mode of the (D1) particles is the most frequent volume in the diameter range of from 1 micron to approximately 10 microns. The mode of the larger particles (D2) is the most frequent diameter by volume (i.e., the peak) within the diameter range of approximately 10 microns to approximately 100 microns. The low end of the diameter range for particles (D1) is defined as the first diameter with a non-zero volume frequency. The high end of the diameter range for particles (D1) is either the first highest diameter with a non-zero volume frequency after the (D1) mode diameter, or the diameter of the first minimum volume frequency that has a higher diameter than the (D1) particle mode after the (D1) mode peak. The low end of the larger particles (D2) diameter range is the smallest diameter with a non-zero volume frequency that is the same diameter or larger than the high end of the diameter range for particles (D1). Thus, the high end of the diameter range for (D1) may be the same as the low end of the diameter range for the particles (D2). The high end of the diameter range for the (D2) particles is the last non-zero volume frequency diameter that has a higher diameter than the mode of the (D2) particles.

After extensive studies, the inventors have surprisingly discovered that when these two distinct (populations) of particle diameter size ranges and modes of particles are present together in the interlayers, they can increase the toughness of the cured BMI CFRP, such that a lower total amount of particles may be needed than when utilizing a single mode size range of particles alone. The particles (D1) may have a particle diameter size range from 1 to 15 microns and a mode by volume of particle diameters of from 4 to 6 microns. The amount of the particles (D1) in the total resin system may be from 3 to 12% by volume of the total thermosetting resin composition. The amount of particles (D1) may be from 1 to 15, or 2 to 13 or, 4 to 10, or 5 to 15, or 1 to 20, or 3 to 15, or 5 to 10% by volume of the total thermosetting resin composition. The particles (D2) contain particles that have a diameter size range from 15 to 100 microns. The amount of the (D2) particles in the total resin system may be from 1 to 6 or from 1 to 13% by volume of the total thermosetting resin composition, or from 0.1 to 10, or 1 to 7, or 2 to 10, or 3 to 8, or 2 to 5, or 0.5 to 4% by volume of the total thermosetting resin composition. Without wishing to be bound by a particular theory, it may be that if the particles (D1) range in diameter from greater than 1 micron to less than 10 microns they may effectively increase the packing level of the (D1) particles in the interlayer, thus increasing the toughness of the CFRP (carbon fiber reinforced part) and increasing the CAI of the CFRP. If the particles (D2) have a diameter range between 10 to 100 microns, or from 15 to 130 microns, without wishing to be bound to any theory, then the particles (D2) may effectively create an interlayer with sufficient thickness to increase the concentration of the particles (D1) within the interlayer, thus effectively increasing the toughness of the CFRP. When the amount of the particles (D1) is from 3 to 12 percent by volume of the total thermosetting resin composition and the amount of the particles (D2) is from 1 to 6 percent by volume of the total thermosetting resin composition, then the CAI may be increased to a higher level higher than when each particle size population (D1) or (D2) is used by itself with the same total volume of particles present. For example, the % by volume of the total thermosetting resin composition of particles (D1) may be from 1 to 45, or 10 to 40, or 15 to 35, or 20 to 30, or 4 to 12, or 1 to 20, or 5 to 15, or 3 to 10% by volume of the total thermosetting resin composition. The % by volume of the total thermosetting resin composition of the particles (D2) may be from 0.5 to 6, or 1 to 6, or 1 to 7, or 1 to 10, or 1 to 15, or 2 to 14, or 3 to 13, or 1.5 to 10, or 5 to 13, or 5 to 10% by volume of the total thermosetting resin composition.

The diameter range of the particles (D1) may be from 1 to 15 or 1 to 14, or 1 to 13, or 2 to 12, or 1 to 10 microns. The mode by volume of the particles (D1) may fall anywhere with these ranges. The mode by volume of the particles (D1) may be from 1 to 15 or 1 to 14, or 1 to 13, or 2 to 12, or 1 to 10 microns or from 3 to 7, or from 4 to 6, or from 2 to 10, or from 3 to 6 microns. Without wishing to be bound by an particular theory, when the (D1) particle is within these ranges they may create a sufficiently tight packing between the (D2) particles that may impart toughness. If the particles are larger than 1 micron they may filter out into the interlayer. If the particles are smaller than 15 microns they may contribute to a higher packing density thus increasing the toughness of the cured CFRP components.

The diameter range of the particles (D2) may be from 10 to 200 microns, or from 10 to 100, or 10 to 90, or 10 to 70, or 10 to 60, or from 11 to 150 or from 12 to 120, or from 13 to 150, or from 14 to 140, or from 10 to 120, or from 15 to 145 microns. The mode by volume of the particles (D2) may fall anywhere within these above-mentioned ranges. The mode by volume of the particles (D2) may be from 10 to 100 microns, or from 20 to 80 or from 40 to 60, or from 10 to 200 microns, or from 11 to 150 or from 12 to 120, or from 13 to 150, or from 14 to 140, or from 10 to 120, or from 15 to 145 microns, or from 20 to 60, or from 15 to 70, or from 30 to 50 microns. Without wishing to be bound to any particular theory, it may be that when the (D2) particles are within this range of sizes they will create a sufficient interlayer thickness to allow use of fewer (D1) particles. This size range may create a thicker interlayer while using fewer of the (D1) particles. Due to the lower amounts of the particles more resin flow may be possible, allowing for better quality CFRP parts and reducing possible void formation especially during low pressure cure such as out of autoclave processing or using fabric architecture as the prepreg substrate.

When all of the above conditions are met, the fracture toughness of the cured composite part or cured prepreg, as measured by CAI may be increased and the CAI of the cured composite or prepreg may be 40 ksi or higher than if the two different particle sizes (D1) and (D2) were not included in the prepreg. Even though similar CAI results may be achieved by incorporating only particles including the smaller diameters of particles (D1), by adding just the smaller particles at higher loadings (by volume), having both the particles (D1) and the particles (D2) present, lower total amounts (by volume) of particles (D1) and (D2) can be used. This is effective in creating a better handling material such as increasing tack and pliability. Also, reducing the amount of particles in the system allows for the ability to control the flow of the resin by adding both dissolved thermoplastic and accelerator in controlled amounts to control tack and resin flow independently of each other.

Not to be bound by any particular theory, it may be that when the particles (D1) are small enough, they may better fill the interstitial volume between the larger particles (D2) and the larger particles (D2) may thus maintain a sufficient thickness for the interlayer. It may be that the smaller particles (D1) may be more efficient at increasing the toughness but cannot maintain a sufficient interlayer thickness to effectively increase the fracture toughness of the carbon fiber reinforced plastic (CFRP). By incorporating a small amount of the larger particles (D2), the interlayer thickness may be maintained while having a larger volume of smaller particles (D1) (relative to the amount of the lager particles (D2)) thus increasing the fracture toughness of the CFRP. Also, it may be that the volume ratio of (D1) to (D2) is important for higher Tg matrix materials due to the very low viscosity of these resin matrix systems during cure. Due to this low viscosity, maintaining the interlayer thickness is very difficult and it was found that when keeping the particles (D1) and (D2) within certain relative amounts between the larger particles (D2) and the smaller particles (D1), the interlayer thickness may be maintained while increasing the effectiveness of the smaller particles (D1) to improve the fracture toughness. This also helps improve the robustness of the properties of the cured CFRP, making different cure cycles and bagging configurations possible without having to stick to very strict curing and bagging schedules that limit the use of other materials similar materials. Furthermore, with the reduced amount by volume of particles in the matrix system, greater flexibility in possible in the amounts of thermoplastic and accelerators used to control the flow and tack of the matrix system.

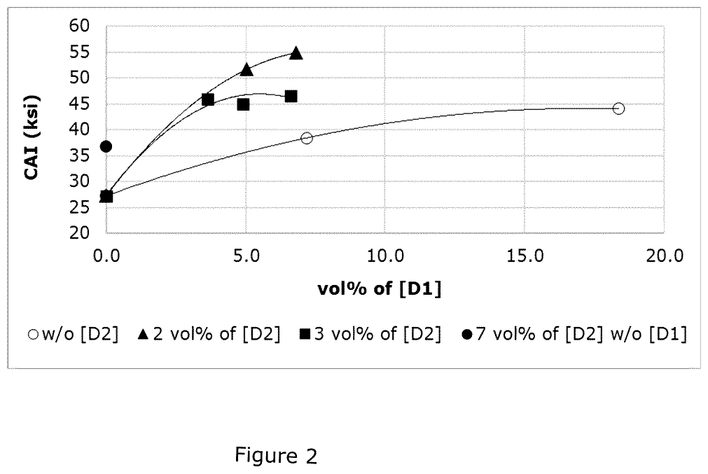

Further, it may be that a certain minimum volume threshold level of the larger particles may be effective to maintain the interlayer thickness, and that adding additional (D2) particles above this threshold level is not necessary to improve significantly the CAI of the cured composite part. If the particle content of the (D2) particle is kept below 6% then the ease of handling of the prepreg is good and resin flow is sufficient to create a fully consolidated and cured CFRP panel with reduced or no voids present. This is particularly advantageous when creating prepreg using a fabric where resin flow is important to fill the free volume during cure reducing the amount of void content. Further advantages to keeping the particle content low include tack control. With a lower particle content, the tack can be controlled using different amounts of dissolved thermoplastic. This may be particularly important to customize the tack of the prepreg, an important property of the prepregs. FIG. 2 shows an example plot of the CAI of a cured composite including no particles (D2), 2% by volume of particles (D2) and 3% by volume of particles (D2). As can be seen in FIG. 2, as the volume percent of the smaller particles (D1) is increased, the CAI of the cured composite increases as well. However, the higher amount, 3% by volume, of the particles (D2) has a lower CAI than the composite made with 2% by volume of the larger particles (D2), at the same loadings of the smaller particles (D1). Also, it may be seen that approximately 7% or 18% by volume of the particles (D1), without the (D2) particles, provide a lower CAI than a cured composite made with approximately 4%, 5% or 6% by volume of (D1) particles that also include either 2% or 3% by volume of (D2) particles.

According to certain embodiments of the current invention, when the (D1) and (D2) particles are combined, the combination may have a particle size distribution similar to FIG. 2 having two distinct modes. In other embodiments the combination may only have one mode. In still other embodiments in which the (D1) particle size distribution has one or more modes and the (D2) particle size distribution has one or more modes, the combined size distribution of the (D1) and (D2) particles may have a size distribution having two or more modes when the size distribution is measured. This combination of particle sizes can have different particle size distributions such as non-symmetric distributions in which the mean, median and mode each have a different value. A particle size distribution may have at least two modes or more such that the (D1) particles are the major mode and minor modes may be made up of both the (D1) particles and the (D2) particles.

Once the particles are combined, then the range of particles sizes at the half height may be between 2 microns to 80 microns. In other embodiments the range of particles may be from 3 microns to 60 microns at the half height of the particle distribution chart and the distribution may have one or more modes.

In certain embodiments, the particles (D1) and (D2) may each have a Tg greater than 200° C. Since the matrix system used has a Tg greater than 200° C., incorporating particles with a Tg less than 200° C. would greatly reduce the mechanical properties of the CFRP especially under elevated temperature and water saturated conditions. In other embodiments, the particles would have a Tg greater than 220° C. Incorporating particles with a Tg greater than 220° C. will greatly increase the thermal oxidative stability of the matrix resin system and ultimately the thermal oxidative stability of the cured CFRP. Particles (D1) and/or particle (D2) with a Tg greater than 220 C° may also reduce the effect on the ultimate Tg of the cured thermosetting resin material. This is especially important for the matrices such as BMI or BOX and certain high temperature Tg epoxies where the cured Tg may be greater than 220° C. For example, the glass transition temperature of the particles (D1) or (D2) may be from 200° C. to 1500° C. or from 220° C. to 1500° C. or higher.

Particles (D1) and (D2) may be formed from the same or different materials. Particles (D1) and (D2) may each be a mixture of various materials. Particles (D1) and/or (D2) that can be incorporated into above-mentioned embodiments of the resin system may be selected from polyimide (PI), polyetherimide (PEI), polyamideimide (PAI), and mixtures thereof. The thermoplastic toughening agent particles (D1) and/or (D2) may be any of the thermoplastic polyimide particles as described in U.S. Pat. Nos. 5,248,711 and 5,120,823, the disclosures of which are incorporated by reference herein in their entireties for all purposes. The particles (D1) and/or (D2) may be formed by the reaction between a dianhydride and a diamine. The particles (D1) and/or (D2) may be formed by crushing or grinding of a polyimide or other thermoplastic material under cryogenic conditions. The particles (D1) and/or (D2) may also be formed by suspension precipitation.

Exemplary suitable toughening agent particles (D1) and/or (D2) that are commercially available include High Performance Powder P84, which is available from Evonik Industries A.G. P84 powder is made in accordance with the teachings of U.S. Pat. No. 4,001,186, the entire contents of which is incorporated by reference herein for all purposes. P84 powder is a polyimide of benzophenone tetracarboxylic anhydride (BTDA), toluenediamine, and 4,4′-diaminodiphenylmethane. Other exemplary thermoplastic toughening agents include polyetherimides, such as ULTEM® 1000, which are available from Sabic (Saudi Arabia, Al-Jubail). High Performance Powder P84 powder may be a preferred thermoplastic toughening agent due to it having the highest Tg of these options. The thermoplastic toughening agent is added in amounts that provide the desired degree of toughening for the prepreg resin consistent with performance requirements for each application.

In certain embodiments, the larger particles (D2) may be comprised of certain inorganic materials. For example, the (D2) particles may be comprised of, consist of, or consist essentially of any type of inorganic particle such as clay. Examples of suitable inorganic particles for (D2) include metallic oxide particles, metallic particles and mineral particles. Examples of other suitable inorganic materials for particles (D2) include aluminum hydroxide, magnesium hydroxide, glass beads, glass flakes, and glass balloons (i.e. hollow glass particles).

Examples of other suitable materials for the particles (D2) include particulate metallic oxides such as silicon oxide, titanium oxide, zirconium oxide, zinc oxide, tin oxide, indium oxide, aluminum oxide, antimony oxide, cerium oxide, magnesium oxide, iron oxide, tin-doped indium oxide (ITO), antimony-doped tin oxide and fluorine-doped tin oxide. Examples of suitable particulate metals for (D2) particles include gold, silver, copper, titanium, aluminum, nickel, iron, zinc and stainless steel. Examples of suitable minerals for particles (D2) include montmorillonite, talc, mica, boehmite, kaolin, smectite, xonotlite, vermiculite and sericite.

Examples of suitable carbonaceous materials for particles (D2) include carbon black, acetylene black, Ketjen black, carbon nanotubes, graphenes, carbon nanofibers, carbon nanobeads, fullerenes, and the like.

First Co-Monomer (A); Maleimide Compound (A)

While the first co-monomer (A) is not particularly limited, according to certain embodiments, it may comprise, consist of, or consist essentially of at least one maleimide compound.

The maleimide or bismaleimide compound comprising the first co-monomer (A) in the present invention may include any of the known bismaleimide compounds. The terms “maleimide” and “bismaleimide” are used interchangeably herein. The bismaleimide compounds of the first co-monomer (A) are typically prepared by reacting maleic anhydride or substituted maleic anhydrides with aromatic and/or aliphatic diamines. Exemplary bismaleimides are as follows: N,N′-4,4′-diphenylmethane-bis-maleimide; N,N′-2,4-toluene-bis-maleimide; N,N′-2,6-toluene-bis-maleimide; N,N′-2,2,4-trimethylhexane-bis-maleimide; N,N′-ethylene-bis-maleimide; N,N′-ethylene-bis(2-methyl)maleimide; N,N′-trimethylene-bis-maleimide; N,N′-tetramethylene-bis-maleimide; N,N′-hexamethylene-bis-maleimide; N,N′-1,4-cyclohexylene-bis-maleimide; N,N′-meta-phenylene-bis-maleimide; N,N′-para-phenylene-bis-maleimide; N,N′-4,4′-3,3′-dichloro-diphenylmethane-bis-maleimide; N,N′-4,4′-diphenyl-ether-bis-maleimide; N,N′-4,4′-diphenylsulfone-bis-maleimide; N,N′-4,4′-dicyclohexylmethane-bis-maleimide; N,N′-α,α′-4,4′-dimethylenecyclohexane-bis-maleimide; N,N′-meta-xylene-bis-maleimide; N,N′-para-xylene-bis-maleimide; N, N′-4,4′-diphenyl-cyclohexane-bis-maleimide; N,N′-meta-phenylene-bis-tetrahydrophthalimide; N,N′-4,4′-diphenylmethane bis-citraconimide; N,N′-4,4′-2,2-diphenylpropane-bis-maleimide; N,N′-4,4-1,1-diphenyl-propane-bis-maleimide; N,N′-4,4′-triphenylmethane-bis-maleimide; N,N′-α,α′-1,3-dipropylene-5,5-dimethyl-hydantoin-bis-maleimide; N,N′-4,4′-(1,1,1-triphenyl ethane)-bis-maleimide; N,N′-3,5-triazole-1,2,4-bis-maleimide; N,N′-4,4′-diphenylmethane-bis-itaconimide; N,N′-para-phenylene-bis-itaconimide; N,N′-4,4′-diphenylmethane-bis dimethyl-maleimide; N,N′-4,4′-2,2-diphenylpropane-bis-dimethyl-maleimide; N,N′-hexamethylene-bis-dimethyl-maleimide; N,N′-4,4′-(diphenyl ether)-bis-dimethyl-maleimide; N,N′-4,4′-diphenylsulphone-bis-dimethylmaleimide; N,N′-(oxydi-para-phenylene)-bis-maleimide; N,N′-(oxydi-para-phenylene)-bis-(2-methylmaleimide); N,N′-(methylene di-para-phenylene)-bis-maleimide; N,N′-(methylene di-para-phenylene)-bis-(2-methylmaleimide); N,N′(methylene di-para-phenylene)-bis-(2-phenylmaleimide); N,N′-(sulfonyl di-para-phenylene)-bis-maleimide; N,N′-(thio di-para-phenylene)-bis-maleimide; N,N′-(dithio di-para-phenylene)-bis-maleimide; N,N′-(sulfonyl di-meta-phenylene)-bis-maleimide; N,N′-(ortho, para-isopropylidene diphenylene)-bis-maleimide; N,N′-(isopropylidene di-para-phenylene)-bis-maleimide; N,N′-(ortho, para-cyclohexylidene diphenylene)-bis-maleimide; N,N′-(cyclohexylidene di-para-phenylene)-bis-maleimide; N,N′-(ethylene di-para-phenylene)-bis-maleimide; N,N′-(4,4″-para-triphenylene)-bis-maleimide; N,N′-(para-phenylenedioxy-di-para-phenylene)-bis-maleimide; N,N′-(methylene di-para-phenylene)-bis-(2,3-dichloromaleimide); and N,N′-(oxy-di-para-phenylene)-bis-(2-chloromaleimide).

Second Co-Monomers (B)

The first co-monomer (A) and the second co-monomer (B) react together to form a thermoset resin.

The bismaleimide monomers used as the first co-monomer (A) described above are seldom used alone, but are most often used as a total resin system which may contain other polymerizable species in addition to fillers, rheology control agents, catalysts, fibrous and non-fibrous reinforcement, and the like. Particularly important in bismaleimide resin systems are various co-monomers and reactive modifiers used as second co-monomer (B).

The second co-monomers (B) may be interactive in that they react with the bismaleimides, or they may only react with themselves or other system components, some of these materials may perform more than one function. Epoxy resins, for example, are generally unreactive with maleimide groups, but may react with other system components, particularly amines, phenols, and anhydrides. In addition, liquid epoxy resins such as those based on bisphenol A or bisphenol F may serve as tackifiers, increasing the layup temperature tack of adhesives, matrix resins, and prepregs.

Among the second co-monomers (B) useful with maleimides and bismaleimides as the first co-monomer (A) are the di- and polyamines and the alkenyl and alkenyl phenols and phenoxyethers. Di- and polyamines useful, for example, include both aliphatic amines such as 1,6-diamino-2,2,4-trimethylhexane, 1,6-hexanediamine, 1,8-octanediamine, bis(3-aminopropyl)ether, and the like; and aromatic amines such as 1,2-, 1,3-, and 1,4-phenylenediamine, 2,4- and 2,6toluenediamine, 2,2′-, 2,4′-, 3,3′-, and 4,4′-diaminodiphenylmethane, and diaminodiphenylmethane analogues in which the bridging methylene group is replaced by a divalent organic group such as —CO—, —COO—, —OCOO—, —SO—, —S—, —SO₂—, —NH—CO—, and the like. Prepolymers prepared from bismaleimides and the aforementioned amines are also useful.

Alkenyl group-containing compounds, particularly alkenyl aromatic compounds may also be suitable second co-monomers (B). Examples of these compounds are styrene, 1,4-divinylbenzene, terephthalic acid diacrylate, cyanuric acid triacrylate, and glyceryl triacrylate. The corresponding allyl, methallyl, methacrylo, and methylvinyl group-containing compounds are also suitable. Among the alkenylphenols and alkenylphenoxy ethers useful are particularly the allyl, methallyl, and propenyl phenols such as o,o′-diallylbisphenol A, eugenol, eugenol methylether, and similar compounds as disclosed in U.S. Pat. No. 4,100,140. Also useful are oligomers which are terminated with allyl- or propenyl phenyl or allyl- or propenylphenoxy groups such the appropriately terminated polysiloxanes, polyetherketones, polyethersulfones, polyimides, polyetherimides, and the like. Suitably terminated oligomers, for example, may be prepared by alkylating phenolated dicyclopentadienes and subsequently rearranging to the allylphenol as taught in U.S. Pat. No. 4,546,129, which is incorporated herein by reference. Most preferably, the alkenylphenol is o,o′-diallylbisphenol A or o, o′-dipropenylbisphenol A. The alkenylphenols and alkenylphenoxy co-monomers are utilized in amounts of up to 70 weight percent based on the total system weight, in some embodiments from 10 to 50 percent, and other embodiments from about 20 to about 40 percent. When the amount of the alkenyl group containing co-monomer is above 10% in the BMI mixture it can have high modulus and high Tg. When it is above 30% it can improve the toughness of the resin and ease of handling.

Specific examples include o,o′-diallylbisphenol A, eugenol, eugenol methylether and similar compounds, as disclosed in U.S. Pat. No. 4,100,140, incorporated by reference herein in its entirety. Particularly preferred second co-monomers (B) are o,o′-diallylbisphenol A and o,o′-dipropenylbisphenol A. Compimide® TM124 is a commercially available co-curing agent that is available from Evonik Industries AG, which contains o,o′-diallylbisphenol A.

Also, useful as second co-monomers (B) are the cyanate ester resins and their reaction products with bismaleimides. The cyanate ester resins contain the —OCN reactive moiety and are generally prepared by the reaction of a cyanogen halide with a di- or polyphenol. Suitable cyanate ester resins and methods for their preparation are disclosed in U.S. Pat. No. 4,546,131, which is herein incorporated by reference.

Prepolymers prepared by the reaction of the cyanate resins with epoxy resins or with bismaleimide resins are also useful. The latter are available commercially from the Mitsubishi Gas Chemical Co. as ‘BT Triazine Resins.’ Epoxy resins may be useful in the resin systems of the subject invention as indicated earlier. Among such resins are those described in the treatise Handbook of Epoxy Resins, Lee and Neville, McGraw-Hill, (C) 1967; and Epoxy Resins Chemistry and Technology, May and Tanaka, Marcel Dekker, C.1973. Among the most useful epoxy resins because of their ability to aid the tack of bismaleimide formulations, are the liquid epoxies, particularly those derived from bisphenol A, bisphenol F, and p-aminophenol. Generally, minor quantities of epoxy resins are utilized, for example up to about 30 percent, more preferably up to 20 percent, and most preferably less than 10 percent by weight.

Toughening modifiers may also be useful in the practice of the subject invention as second co-monomer (B). Generally, these are reactive oligomers having molecular weights of between 600 and 30,000 Daltons. These modifiers may be terminated or have medial reactive groups such as the allyl or propenylphenols and phenoxy ethers discussed previously, or amino, maleimide, cyanate, isocyanurate, or other groups reactive with bismaleimides. The backbone of these oligomers may be of diverse nature, for example polyarylene such as the polyetherketones, polyetheretherketones, polysulfones, polyethersulfones and the like as prepared in U.S. Pat. No. 4,175,175 and in the article Toughening of Bis Maleimide Resins. Synthesis and Characterization of Maleimide Terminated Poly(Arylene Ether) Oligomers and Polymers, J. E. McGrath, et. al., NASA report n187-27036, Final Report Task 1-17000, the contents of both of which are incorporated by reference herein for all purposes. The backbone may also be derived from poly siloxanes or, in particular, poly(dicyclopentadienes) terminated with allyl or propenyl phenol or phenoxy groups.

Dissolved Thermoplastic (C)

In certain embodiments, tack may need to be adjusted. With the increase in use of different types of manufacturing, adjusting the tack of the product has become important. When tack is high, hand layup of the prepreg can be done. When tack is low, Automated Fiber Placement (AFP) and Automated Tape Layup (ATL) can be accomplished. The tack can be adjusted by adding a soluble thermoplastic to the resin matrix. For the exemplary matrix resin BMI, the thermoplastic that is soluble in the BMI or BOX matrix system may be a polyimide, such as Matrimide® 5218, or may be a different type of polymer, for example a reactive or non-reactive polysulfone, polyethersulfone, polyetherketone, polyetheretherketone or the like. The weight averaged molecular weight (Mw) of this additional, soluble thermoplastic may be from about 2000 to about 150,000 Daltons, but is preferably from 20,000 to about 100,000 Daltons. If the Mw of the soluble thermoplastic is from 20,000 to about 100,000 Daltons, then the amount of soluble thermoplastic that can be dissolved can be from 0 to 5% by weight, exclusive of the particles (D1) and (D2) in the thermosetting resin system. If there is no soluble thermoplastic in the resin system, then the tack of the prepreg may be high and thus suitable for hand layup. If there is less than 5% by weight of the soluble resin thermoplastic in the thermosetting matrix, exclusive of the particles (D1) and (D2), the tack may be low enough to work well with AFP/ATL systems. With these systems sometimes, it is preferable to have low tack at room temperature and high tack when heated. If the particles and thermoplastic are included at too high a volume and weight percent, even heating may not create sufficient tack, thus creating poor conditions for the AFP/ATL systems. Furthermore, if the thermoplastic is present at below 5% by weight, then the prepreg will be easy to drape and handle and not be brittle.

Although the soluble thermoplastic may be added to adjust the room temperature viscosity (which is related to the tack) of the thermosetting matrix system, the difficulty of adding high temperature thermosetting matrix systems is the very steep viscosity curve that results in the thermosetting resin during cure. Thus, once the room temperature viscosity is set by the soluble thermoplastic dissolved into the thermosetting matrix, the minimum viscosity and total flow index remains too low at the cure temperatures for the thermosetting resin, thus creating too much flow of the resin during the cure. This causes problems with the manufacturing of parts by creating uneven part thicknesses. Also, with increased flow, the interlayer thickness of the prepreg becomes more difficult to control, and the number of particles in the interlayer may vary. When the resin flow is high, certain complex bagging techniques are needed to reduce the resin flow, thereby increasing the complexity and time to create such bagging. It has been found that incorporating an accelerator specific to the high temperature resin system together with the thermoplastic can control the minimum viscosity and total flow index of the matrix system during cure, while not affecting the room temperature viscosity. This reduced resin flow allows for less complex bagging techniques, thereby greatly decreasing the amount of time needed to manufacture the CFRP parts. The difficulty with this approach, is selecting the correct amount of accelerator such that the ease of processing of the prepreg is not affected.

Accelerators/Catalysts (E):

For the exemplary matrix system, BMI, the catalysts, also referred to herein as accelerators, are well known to those skilled in the art, for example tertiary amines; metal carboxylates, e.g. tin(II) octoate; and particularly the organophosphines, organophosphine salts, complexes, and the reaction products of maleimide group containing compounds and organophosphines such as those disclosed as useful for epoxy resin systems in U.S. Pat. No. 3,843,605, the entire contents of which are incorporated by reference herein.

In certain embodiments of the current invention, the organophosphines are used to catalyze the BMI matrix system. In these embodiments, the amount of catalyst to be used is from 0.01% to 0.5% by weight of the first and second co-monomers (A) and (B). If the amount of catalyst is above 0.01% and combined with the above amounts of the soluble thermoplastic system, the tack, minimum viscosity and resin flow index can be adjusted to acceptable levels for both ease of handling and proper resin flow during the cure of the thermosetting resin system. If the amount of catalyst is below 0.5% by weight of the thermosetting resin components (A) and (B) then the matrix system can be successfully processed through prepregging systems which includes mixing, filming and prepregging of the fibers, without undue premature crosslinking.

Viscosity of the Thermosetting Resin Composition at 40° C.

The viscosity of the BMI resin composition at 40° C. may be between 1×10³ and 3×10⁴ Pa·s, in order to achieve both easy handling and processing of the uncured FRC prepreg while maintaining the mechanical properties of the cured FRC. If the viscosity at 40° C. is too low, the ease of handling may be compromised because the tack may be too high. If the viscosity at 40° C. is too high, the ability to mold the uncured FRC may be unsatisfactory because the tack may be too low and the prepreg becomes too brittle. Also, the minimum viscosity of the thermosetting resin composition at 40° C. should be greater than 1 Pas. If the minimum viscosity is too low, then the resin flow will be too great and special handling and molding procedures will be needed, making the material difficult to work with (such as by losing too much resin due to bleed out). The viscosity of the thermosetting resin composition was measured using a dynamic viscoelasticity measuring device (ARES, manufactured by TA Instruments) using parallel plates with a diameter of 40 mm while increasing the temperature at a rate of 2° C./min, with a strain of 10%, frequency of 0.5 Hz, and plate interval of 1 mm, from to 150° C. The viscosity of the thermosetting maleimide or BMI resin composition may be adjusted and controlled as may be desired by selecting particular components for use in the composition. In particular, the types and relative proportions of the maleimide resins and co-monomers present as components (A) and (B) may be varied as needed to adjust the viscosity of the overall thermosetting resin composition.

Other Additives

Furthermore, additional inorganic particulate materials such as clay may be included in the BMI resin composition, as long as the effect of the present invention is not deteriorated. If the inorganic particulate materials are within the same size distribution as the (D1) particles, then the amount of the (D1) particles may be reduced to keep the same volume distribution. An advantageous effect of certain embodiments of this invention is that a high volume of thermoplastic (D1) particles is not needed to increase the CAI. This allows for the addition of other particles that may provide other properties that might be more desirable to certain embodiments of the current invention. If the additional particles are within the same size distribution as the (D2) particles, then these particles can be used to help enhance the CAI along with the other properties that the additional inorganic particles enhance. Even though these particles might not be as effective as certain thermoplastic particles they may still be used to create the interlayer thickness that is may enhance the CAI and reduce the overall volume of particles needed in the interlayer. If the particles are smaller than the sizes of (D1) than these particles would be mostly dispersed into the intralayer, between the fibers, and would not have a large effect on the CAI and not have a large effect on the properties of certain embodiments of the current invention. Non-limiting examples of suitable inorganic particles include metallic oxide particles, metallic particles and mineral particles. The inorganic particles may be used to improve one or more functions of the cured thermosetting resin composition and to impart one or more functions to the cured thermosetting resin composition. Examples of such functions include surface hardness, anti-blocking property, heat resistance, barrier property, conductivity, antistatic property, electromagnetic wave absorption, UV shield, toughness, impact resistance, and low coefficient of linear thermal expansion. Examples of other suitable inorganic materials include aluminum hydroxide, magnesium hydroxide, glass beads, glass flakes and glass balloons.

The inorganic particles may be in the range of 1 nm to 10 μm. Any shape inorganic particles may be used; for example, the inorganic particles may be spherical, needles, plates, balloons or hollow in shape. The inorganic particles may be just used as powder or used as a dispersion in a solvent-like sol or colloid. Furthermore, the surface of the inorganic particle may be treated by a coupling agent to improve the dispersion of the particles and the interfacial affinity with the BMI resin.

Examples of suitable particulate metallic oxides include silicon oxide, titanium oxide, zirconium oxide, zinc oxide, tin oxide, indium oxide, aluminum oxide, antimony oxide, cerium oxide, magnesium oxide, iron oxide, tin-doped indium oxide (ITO), antimony-doped tin oxide and fluorine-doped tin oxide. Examples of suitable particulate metals include gold, silver, copper, aluminum, nickel, iron, zinc and stainless. Examples of suitable minerals include montmorillonite, talc, mica, boehmite, kaolin, smectite, xonotlite, vermiculite and sericite.

Examples of other suitable carbonaceous materials include carbon black, acetylene black, Ketjen black, carbon nanotubes, graphenes, carbon nanofibers, carbon nanobeads, fullerenes, etc.

In certain embodiments, the BMI resin composition may contain one or more other materials in addition to the abovementioned materials, as long as the effect of the present invention is not deteriorated. Examples of other materials include mold release agents, surface treatment agents, flame retardants, antibacterial agents, leveling agents, antifoaming agents, thixotropic agents, heat stabilizers, light stabilizers, UV absorbers, pigments, coupling agents and metal alkoxides.

Reinforcing Fibers

There are no specific limitations or restrictions on the type of a reinforcing fiber that can be used, as long as the effects of the invention are not deteriorated. Examples include glass fibers, carbon fibers, and graphite fibers such as S glass, S-1 glass, S-2 glass, S-3 glass, E-glass, and L-glass fibers, organic fibers such as aramid fibers, boron fibers, metal fibers such as alumina fibers, silicon carbide fibers, tungsten carbide fibers, and natural/bio fibers. Particularly, the use of carbon fiber may provide cured FRC materials which have exceptionally high strength and stiffness and which are lightweight as well. Examples of suitable carbon fibers are those from Toray Industries having a standard modulus of about 200-250 GPa (Torayca® T300, T3003, T400H, T600S, T700S, T700G), an intermediate modulus of about 250-300 GPa (Torayca® T800H, T800S, T1000G, M305, M30G), or a high modulus of greater than 300 GPa (Torayca® M40, M353, M403, M463, M503, M553, M603). Among these carbon fibers, one with standard modulus, strength of 4.9 GPa or higher and elongation of 2.1% or higher is used in the examples.

The form and the arrangement of a layer of reinforcing fibers used are not specifically limited. Any of the forms and spatial arrangements of the reinforcing fibers known in the art such as long fibers in a direction, chopped fibers in random orientation, single tow, narrow tow, woven fabrics, mats, knitted fabrics, and braids may be employed. The term “long fiber” as used herein refers to a single fiber that is substantially continuous over 10 mm or longer or a fiber bundle comprising the single fibers. The term “short fibers” as used herein refers to a fiber bundle comprising fibers that are cut into lengths of shorter than 10 mm. Particularly in the end use applications for which high specific strength and high specific elastic modulus are desired, a form wherein a reinforcing fiber bundle is arranged in one direction may be most suitable. From the viewpoint of ease of handling, a cloth-like (woven fabric) form is also suitable for the present invention.

Manufacturing Methods:

The FRC materials of the present invention may be manufactured using methods such as the prepreg lamination and molding method, resin transfer molding method, resin film infusion method, hand lay-up method, sheet molding compound method, filament winding method and pultrusion method, though no specific limitations or restrictions apply in this respect.

The resin transfer molding method is a method in which a reinforcing fiber base material is directly impregnated with a liquid thermosetting resin composition and cured. Since this method does not involve an intermediate product, such as a prepreg, it has great potential for molding cost reduction and is advantageously used for the manufacture of structural materials for spacecraft, aircraft, rail vehicles, automobiles, marine vessels and so on.

The prepreg lamination and molding method is a method in which a prepreg or prepregs, produced by impregnating a reinforcing fiber base material with a thermosetting resin composition, is/are formed and/or laminated, followed by the curing of the resin through the application of heat and pressure to the formed and/or laminated prepreg/prepregs to obtain an FRC material.

The filament winding method is a method in which one to several tens of reinforcing fiber rovings are drawn together in one direction and impregnated with a thermosetting resin composition as they are wrapped around a rotating metal core (mandrel) under tension at a predetermined angle. After the wraps of rovings reach a predetermined thickness, it is cured and then the metal core is removed.

The pultrusion method is a method in which reinforcing fibers are continuously passed through an impregnating tank filled with a liquid thermosetting resin composition to impregnate them with the thermosetting resin composition, followed by processing through a squeeze die and heating die for molding and curing, by continuously drawing the impregnated reinforcing fibers using a tensile machine. Since this method offers the advantage of continuously molding FRC materials, it is used for the manufacture of FRC materials for fishing rods, rods, pipes, sheets, antennas, architectural structures, and so on. Of these methods, the prepreg lamination and molding method may be used to give excellent stiffness and strength to the FRC materials obtained.

Prepregs may contain the high temperature BMI resin composition and reinforcing fibers. Such prepregs may be obtained by impregnating a reinforcing fiber base material with BMI resin composition of the present invention. Impregnation methods include the wet method and hot-melt method (dry method).

The wet method is a method in which reinforcing fibers are first immersed in a solution of a BMI resin composition, created by dissolving the BMI resin composition in a solvent, such as methyl ethyl ketone or methanol, and retrieved, followed by the removal of the solvent through evaporation via an oven, etc. to impregnate reinforcing fibers with the thermosetting resin composition. The hot-melt method may be implemented by impregnating reinforcing fibers directly with BMI resin composition, made fluid by heating in advance, or by first coating a piece or pieces of release paper or the like with an BMI resin composition for use as resin film and then placing a film over one or either side of reinforcing fibers as configured into a flat shape, followed by the application of heat and pressure to impregnate the reinforcing fibers with the resin. The hot-melt method may give a prepreg having virtually no residual solvent in it.

The prepreg may have a carbon fiber areal weight of between 40 to 500 g/m². If the carbon fiber areal weight is less than 40 g/m², there may be insufficient fiber content, and the fiber reinforced composite (FRC) material may have low strength. If the carbon fiber areal weight is more than 500 g/m², the ease of draping the prepreg may be impaired and the effect of the interlayer particles reduced. The prepreg may also have a resin content of between 20 to 70 wt %. If the resin content is less than the impregnation may be unsatisfactory, creating large number of voids. If the resin content is more than 70 wt %, the FRC mechanical properties will be impaired.

Appropriate heat and pressure may be used under the prepreg lamination and molding method, the press molding method, autoclave molding method, bagging molding method, wrapping tape method, internal pressure molding method, or the like.

The autoclave molding method is a method in which prepregs are laminated on a tool plate of a predetermined shape and then covered with bagging film, followed by curing, performed through the application of heat and pressure while air is drawn out of the laminate. It may allow precision control of the fiber orientation, as well as providing high-quality molded materials with excellent mechanical characteristics, due to a minimum void content. The pressure applied during the molding process may be 0.3 to 1.0 MPa, while the molding temperature may be in the 90 to 300° C. range (in one embodiment of the invention, in the range of 180° C. to 220° C., or 200° C. to 220° C.).

The wrapping tape method is a method in which prepregs are wrapped around a mandrel or some other cored bar to form a tubular FRC material. This method may be used to produce golf shafts, fishing poles and other rod-shaped products. In more concrete terms, the method involves the wrapping of prepregs around a mandrel, wrapping of wrapping tape made of thermoplastic film over the prepregs under tension for the purpose of securing the prepregs and applying pressure to them. After curing of the resin through heating inside an oven, the cored bar is removed to obtain the tubular body. The tension used to wrap the wrapping tape may be 20 to 100 N. The curing temperature may be in the 90 to 300° C. range (in one embodiment of the invention, in the range of 180° C. to 220° C., e.g., 200° C. to 220° C.).

The internal pressure forming method is a method in which a preform obtained by wrapping prepregs around a thermoplastic resin tube or some other internal pressure applicator is set inside a metal mold, followed by the introduction of high-pressure gas into the internal pressure applicator to apply pressure, accompanied by the simultaneous heating of the metal mold to mold the prepregs. This method may be used when forming objects with complex shapes, such as golf shafts, bats, and tennis or badminton rackets. The pressure applied during the molding process may be 0.1 to 2.0 MPa. The molding temperature may be between room temperature and 300° C. or in the 180 to 275° C. range (in one embodiment of the invention, in the range of 180° C. to 220° C., e.g., 200° C. to 220° C.).

A method of making a thermosetting resin composition is also provided. The method comprises, consists of, or consists essentially of a step of combining the following:
a first co-monomer (A),
a second co-monomer (B),
particles (D1), and
particles (D2).

The particles (D1) and (D2) are insoluble in the first co-monomer (A) and the second co-monomer (B). The particles (D1) have a range of particle diameters from 1 to 10 microns and a mode on a volume basis from 3 to 6 microns, and the particles (D1) comprise from 3 to 12 percent by volume of the total thermosetting resin composition. The particles (D2) have a range of particle diameters from 10 to 100 microns and a mode on a volume basis from 20 to 60 microns and the particles (D2) comprise from 1 to 6 percent by volume of the total thermosetting resin composition.

According to an embodiment, the first co-monomer (A) and the second co-monomer (B) may be first combined to form a monomer mixture and then the particles (D1) and (D2) may be combined with the monomer mixture to form the thermosetting resin composition. According to another embodiment, the particles (D1) and the particles (D2) may be combined to form a particle mixture, such that the particle mixture comprises, consists of or consists essentially of two or more modes. This particle mixture comprising, consisting of, or consisting essentially of two or more modes may then be combined with either the first co-monomer (A) or the second co-monomer (B) and then subsequently combined with the other of co-monomer (A) or co-monomer (B) to form the thermosetting resin. According to yet another embodiment, the particle mixture comprising, consisting of, or consisting essentially of two or more modes may be combined with the monomer mixture to form the thermosetting resin composition.

Applications:

The FRC materials that contain cured thermosetting resin compositions obtained from thermosetting resin compositions of the present invention and reinforcing fibers are advantageously used in general industrial applications, as well as aeronautics and space applications. The FRC materials may also be used in other applications such as sports applications (e.g. golf shafts, fishing rods, tennis or badminton rackets, hockey sticks and ski poles) and structural materials for vehicles (e.g. automobiles, bicycles, marine vessels and rail vehicles, drive shafts, leaf springs, windmill blades, pressure vessels, flywheels, papermaking rollers, roofing materials, cables, and repair/reinforcement materials).

The invention may be summarized according to the following non-limiting

### Aspects.

1: A fiber reinforced prepreg comprising reinforcement fibers and a thermosetting resin composition comprising:
a first co-monomer (A),
a second co-monomer (B), and
particles (D);
wherein the particles (D) are insoluble in the first co-monomer (A) and the second co-monomer (B) and the particles (D) comprise from 4 to 18 percent by volume of the total thermosetting resin composition in the prepreg and have a range of particle diameters from 1 to 100 microns and at least one mode on a volume basis from 3 to 60 microns; and
wherein at least one of conditions i) or ii) is met:
i) the first co-monomer (A) comprises a maleimide compound and the second co-monomer (B) comprises at least one of an alkenylphenol group, an alkenylphenoxy group, or a diamine group; or
ii) the particles (D) comprise particles (D1), from 3 to 12 percent by volume of the total thermosetting resin composition in the prepreg, having a range of particle diameters from 1 to 10 microns and a mode on a volume basis from 3 to 6 microns; and particles (D2), from 1 to 6 percent by volume of the total thermosetting resin composition in the prepreg, having a range of particle diameters from 10 to 100 microns and a mode on a volume basis from 20 to 60 microns.

Aspect 2. The fiber reinforced prepreg of Aspect 1, wherein a cured composite made from the fiber reinforced prepreg has a compressive strength after impact (CAI) of 35 ksi or more measured according to ASTM D7137M-17 after being impacted at 4.45 kJ/m when at least one of conditions i) or ii) is met.

Aspect 3: The fiber reinforced prepreg of Aspect 1 or Aspect 2, wherein the prepreg comprises a fiber layer and an interlayer, and:

[symbol]

Aspect 9: The fiber reinforced prepreg of any of Aspects 1-8, wherein the particles (D) have a glass transition temperature of 200° C. or higher, preferably 220° C. or higher.

Aspect 10: The fiber reinforced prepreg of any of Aspects 1-9, wherein the thermosetting resin composition further comprises a thermoplastic (C) dissolved therein.

Aspect 11: The fiber reinforced prepreg of Aspect 10, wherein the thermoplastic (C) comprises polyimide and is present in an amount from 0.5 to 5% by weight of the total thermosetting resin composition, exclusive of the weight of particles (D1) and (D2).

Aspect 12: The fiber reinforced prepreg of any of Aspects 1-11, wherein the thermosetting resin composition further comprises an accelerator in an amount sufficient to reduce the resin flow index of the thermosetting resin composition to 5 or less.

Aspect 13: The fiber reinforced prepreg of Aspect 12, wherein the amount of accelerator is from 0.05 to 0.5% by weight of components (A) and (B).

Aspect 14: The fiber reinforced prepreg of Aspect 12 or Aspect 13, wherein the accelerator comprises a phosphorous-containing accelerator.

Aspect 15: The fiber reinforced prepreg of any of Aspects 1-14, wherein the maleimide compound (A) comprises at least one of N,N′-4,4′-diphenylmethane-bis-maleimide, N,N′-2,4-toluene-bis-maleimide, N,N′-2,2,4-trimethylhexane-bis-maleimide, or mixtures thereof.

Aspect 16: The fiber reinforced prepreg of any of Aspects 1-15, wherein the maleimide compound (A) comprises a eutectic mixture of two or more bismaleimide compounds.

Aspect 17: The fiber reinforced prepreg of any of Aspects 1-16, wherein the co-monomer (B) comprises o,o′-diallylbisphenol A.

Aspect 18: A thermosetting resin composition comprising:
a first co-monomer (A),
a second co-monomer (B), and
particles (D);
wherein the particles (D) are insoluble in the first co-monomer (A) and the second co-monomer (B) and the particles (D) comprise from 4 to 18 percent by volume of the total thermosetting resin composition in the prepreg and have a range of particle diameters from 1 to 100 microns and at least one mode on a volume basis from 3 to 60 microns; and
wherein at least one of the conditions i) or ii) is met:
i) the first co-monomer (A) comprises a maleimide compound and the second co-monomer (B) comprises at least one of an alkenylphenol group, or an alkenylphenoxy group, or a diamine group; or
ii) the particles (D) comprises particles (D1) having a range of particle diameters from 1 to 10 microns and a mode on a volume basis from 3 to 6 microns, and the particles (D1) comprise from 3 to 12 percent by volume of the total thermosetting resin composition; and particles (D2) having a range of particle diameters from 10 to 100 microns and a mode on a volume basis from 20 to 60 microns, and the particles (D2) comprise from 1 to 6 percent by volume of the total thermosetting resin composition.

Aspect 19: The thermosetting resin composition of Aspect 18, wherein a volume ratio of particles (D1) to particles (D2) is from 90:10 to 50:50.

Aspect 20: The thermosetting resin composition of Aspect 18 or Aspect 19, wherein the particles (D1) comprise polyimide particles.

Aspect 21: The thermosetting resin composition of any of Aspects 18-20, wherein the particles (D2) have a range of particle diameters of from 20 to 60 microns and a mode on a volume basis from 20 to 40 microns.

Aspect 22: The thermosetting resin composition of any of Aspects 18-21, wherein the particles (D1) have a glass transition temperature of 200° C. to 400° C., preferably 220° C. to 400° C., more preferably 220° C. or higher.

Aspect 23: The thermosetting resin composition of any of Aspects 18-22, wherein the thermosetting resin composition further comprises a thermoplastic (C) dissolved therein.

Aspect 24: The thermosetting resin composition of Aspect 23, wherein the thermoplastic (C) comprises polyimide.

Aspect 25: The thermosetting resin composition of any of Aspects 18-24, wherein the thermosetting resin composition further comprises an accelerator in an amount sufficient to reduce the resin flow index of the thermosetting resin to 5 or less.

Aspect 26: The thermosetting resin composition of Aspect 25, wherein the amount of accelerator is from 0.05 to 0.5% by weight of components (A) and (B).

Aspect 27: The thermosetting resin composition of Aspect 25 or Aspect 26, wherein the accelerator comprises a phosphorous containing accelerator.

Aspect 28: The thermosetting resin composition of any of Aspects 18-27, wherein the maleimide compound (A) comprises at least one of N,N′-4,4′-diphenylmethane-bis-maleimide, N,N′-2,4-toluene-bis-maleimide, N,N′-2,2,4-trimethylhexane-bis-maleimide, or mixtures thereof.

Aspect 29: The thermosetting resin composition of any of Aspects 18-28, wherein the second co-monomer (B) comprises o,o′-diallylbisphenol A.

Aspect 30: A method of making a thermosetting resin composition, the method comprising combining:
a first co-monomer (A),
a second co-monomer (B),
particles (D1), and
particles (D2);
wherein the particles (D1) and (D2) are insoluble in the first co-monomer (A) and the second co-monomer (B) and the particles (D1) have a range of particle diameters from 1 to 10 microns and a mode on a volume basis from 3 to 6 microns, and the particles (D1) comprise from 3 to 12 percent by volume of the total thermosetting resin composition; and the particles (D2) have a range of particle diameters from 10 to 100 microns and a mode on a volume basis from 20 to 60 microns and the particles (D2) comprise from 1 to 6 percent by volume of the total thermosetting resin composition.

Aspect 31: The method of Aspect 30, wherein the first co-monomer (A) and the second co-monomer (B) are combined to form a monomer mixture and then the particles (D1) and (D2) are combined with the monomer mixture to form the thermosetting resin composition.

Aspect 32: The method of Aspect 31, wherein the particles (D1) and the particles (D2) are combined to form a particle mixture and the particle mixture comprises two or more modes, and wherein the particle mixture is then combined with the monomer mixture to form the thermosetting resin composition.

Aspect 33: The method of Aspect 30, wherein the particles (D1) and the particles (D2) are combined to form a particle mixture and the particle mixture comprises two or more modes.

Aspect 34. The method of Aspect 33, wherein the particle mixture is combined with either the first co-monomer (A) or the second co-monomer (B) and then subsequently combined with the other of co-monomer (A) or co-monomer (B) to form the thermosetting resin.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the composition or process. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

### Examples

Embodiments of the present invention are now described in more detail by way of examples. The measurement of various properties was carried out using the methods described below. These properties were, unless otherwise noted, measured under environmental conditions comprising a temperature of 23° C. and a relative humidity of 50%. Prepreg was then made from the example resins using a hot melt prepreg method. The components used in the working examples and comparative examples that are shown in Table 1 (working examples) and Table 2 (comparative examples) are as follows.

Reinforcement fibers: Carbon Fiber “Torayca®” Fibers, manufactured by Toray as described below were used in the Examples and Comparative Examples.

Component A, maleimide compounds: Compimide® 353A (produced by Evonik Industries AG), N,N′-4,4′-diphenylmethane-bis-maleimide, N,N′-2,4-toluene-bis-maleimide and N,N′-2,2,4-trimethylhexane-bis-maleimide

Component B, co-monomers: Compimide® TM124 (produced by Evonik Industries AG), o,o′-diallylbisphenol A

Component C, thermoplastic Matrimid® 9725.

Particles (D1): Polyimide P84® NT SF from Evonik Industries (nominal size-1-microns)

Particles (D2): Polyimide P84® NT F from Evonik Industries (nominal size-10-100 microns)

For this subject invention, the examples used bismaleimide resin but should not be limited to just bismaleimide but also other high temperature materials such as Benzoxazine (BOX), and high temperature epoxies that have Tgs greater than 200° C. are contemplated as embodiments of this invention.

### Measurement of Glass Transition Temperature of Cured Resin (Tg by DMA Torsion)

The resin composition was dispensed into a mold cavity set for a thickness of 2 mm using a 2 mm-thick metal spacer. Then, the resin composition was cured by heat treatment in a convection oven with the curing condition 1 and 2 above to obtain a 2 mm-thick cured resin plate. A test piece with a length of 50 mm and a width of 12.7 mm was cut out of the aforementioned plate and subjected to a Tg measurement in 1.0 Hz torsion mode using a dynamic viscoelasticity measuring device (ARES, manufactured by TA Instruments) by heating it to temperatures of 40° C. to 350° C. at a rate of 5° C./min in accordance with SACMA (Suppliers of Advanced Composite Materials) SRM (SACMA Recommended Methods) 18R-94 (glass transition temperature measurement). Tg was determined by finding the intersection between the tangent line of the glass region and the tangent line of the transition region from the glass region to the rubber region on the temperature-storage elasticity modulus curve, and the temperature at that intersection was considered to be the glass transition temperature, commonly referred to as G′ onset Tg.

### Measurement of Compression After Impact (CAI)

A CFRP panel was prepared by the method described in “curing of prepreg” with the following lay-up configuration of [+45909-45790° ]35 24 ply. After cure, the CFRP panel was machined into test coupons with a size of 4 inches by 6 inches. The test coupons were tested per ASTM standard ASTM D 7137M-17. The compression strength of each coupon was tested per ASTM standard ASTM D 7137M-17 after being impacted at 1000 in-lb per inch thickness (4.45 kJ/m).

### Fiber Areal Weight

Resin Areal Weight (RAW) was determined by taking the filmed resin, prior to prepregging, and cutting out 100×100 mm square samples, scraping off the resin on the squares, and measuring the weight of the resin. The areal weight is twice this weight divided by the area of the square sample. Fiber Areal Weight (FAW) was measured via a similar method post-prepregging, by cutting out 100×100 mm square samples, weighing the prepreg and subtracting the RAW from this value.

### Resin Content in the Prepreg

The Resin Content (RC) is the % by weight of the resin in the prepreg was calculated as:

RC=RAW/[(RAW+FAW)]

### Uncured Resin Viscosity

Uncured resin specimens were placed in a 40 mm diameter parallel plate rheometer (ARES, manufactured by TA Instruments) with a gap of 0.6 mm, preheated to 40° C. Torsional displacement was applied at 10 rad/s. The temperature was increased at 2° C./min until the minimum viscosity of the resin was determined.

### Particle Size Measurement

The particles were measured using static light scatter methods and Mie theory (assuming spherical particles, similar to the wavelength of the incident light) to analyze the results, utilizing the following method and instrument. The instrument used was a Mastersizer 2000 using a Scirocco 2000 cell cassette for dry method measurements. The Mastersizer 2000 was set to the following settings:
Dispersing medium=Air
Absorption Value=0
Refractive index=1.50
Obscuration setting=1-12%
Dispersing Condition=0.35 bar @ 65%
Gap width of gate=˜0.125″ (˜0.318 cm)

The measurement time for each sample was set to 6 seconds.

As is known in the art, the results are reported as a frequency distribution curve, i.e. the frequency of the diameter is plotted on the y-axis, vs. the particle size in diameter on the x-axis. The results may be analyzed to determine the range and the mode of each peak thus provided.

The measurements reported are the particle size in diameter per volume percent (%) of the total particles.

### Particle Size Measurement (Optical Microscopy)

Another method available to determine the particle size distribution is Optical Microscopy. This method for determining the volume % of particles in the interlayer and intralayer is as follows. A cure cured sample was cut and cross-sectioned and polished to a 3-micron finish or better using a polishing wheel. This was accomplished by using an automated polishing machine such as the Tegramin apparatus available from Struers. Once polished, the volume distribution of particle sizes was measured using a microscope with 300× or greater and Zeiss Zen software with particle size and count modules. Once the sizes were determined, the particle size distribution chart was created. If the particles are hard to resolve, a fluorescent light source with the appropriate filter can be used to increase the contrast between the particles and the matrix resin.

### Resin Flow Index

The resin flow index is calculated from the uncured resin viscosity. The uncured resin viscosity is measured as described above. After the uncured resin viscosity from to 140° C. is measured, the flow index was calculated using the following equation:

$$Flow Index = {\sum }_{k = 40 ° C}^{140 ° C} ( \frac{1}{viscosity ( P )} )$$

### Tack

Tack was measured at 25° C. and 90° C. @ 50% relative humidity according to the procedure described in the paper published in Composites Part A: Applied Science and Manufacturing, 114, 295-306, incorporated by reference herein for all purposes. The following parameters were used for the testing of the tack:
Coupon size: 215 mm×75 mm
Rate: 3″/min
Roller compaction: 100N
Test: Tack to self (prepreg to prepreg)

The tack was compared to 3900-2B/T800S standard prepreg and considered to be “high tack” “med tack “low tack”.

Volume Percent of Particles Remaining in the Interlayer after Cure

The method for determining the volume % of particles in the interlayer and intralayer is the following. A cure cured sample was cut, cross-sectioned, and polished to a 3 micron finish or better using a polishing wheel. This was accomplished using an automated polishing machine such as the Tegramin from Struers. Once polished using a microscope with 300× or greater magnification, the surface was analyzed using Zeiss Zen software with particle size and count modules to measure the volume % of particles in the interlayer and intralayer. If the particles are hard to resolve, a fluorescent light source with the appropriate filter can be used to improve contrast of the particles and the matrix resin.

### Production of Thermosetting Resin Composition

A predetermined amount of the second co-monomer (B) and a thermoplastic resin (C) were mixed in accordance with the number of blended parts and heated at 120° C. for 1 hour to dissolve the thermoplastic resin. In addition, bismaleimide compound as first co-monomer (A) was separately melted at 140° C. The mixture and the bismaleimide compound as first co-monomer (A) were mixed after the temperature was lowered to 100° C., and an accelerator was further added at 60° C., followed by kneading to prepare a high heat-resistant thermosetting resin composition. Tables 1-4 summarize the composition of various exemplary resin compositions and properties of the resulting cured resins.

### Production of Prepregs

A prepreg comprising the carbon fiber impregnated with the specified resin composition was prepared. The resin composition prepared as described in the Tables was coated onto a release paper with a knife coater to produce two sheets of resin films with a resin mass per unit area of 52 g/m². The aforementioned two sheets of fabricated resin film were overlaid on both sides of the carbon fiber configuration (a mass per unit area of 190 g/m²) arranged in one direction, and heat and pressure were applied with a heat roll at a temperature of 100° C. and a pressure of 1 atm to impregnate the carbon fibers with the thermosetting resin composition, and the particles (D1) and (D2) thus yielding a prepreg. For examples 1-8, 10-13 and comparative examples 1, and 4-11, Torayca® Fiber T1100G-F1E was used to produce the prepregs. For the comparative examples 2 and 3, as well as working example 9, Torayca® Fiber T1100G-51E was used to produce the prepregs.

### Curing of Prepreg

The prepreg obtained above was cut and laminated, subjected to vacuum bag molding, and cured in an autoclave with vacuum applied until the pressure exceeded PSI using the following Curing Condition 1. 85 PSI was applied during the initial temperature ramp and was maintained for the entire cure cycle. The prepreg was post-cured in a convection oven using the following Curing Condition 2.

Curing Condition 1:
1. temperature raised at a rate of 1.7° C./min from room temperature to 143° C.;
2. held for two hours at 143° C.;
3. temperature raised at a rate of 1.7° C./min from 143° C. to 190° C.;
4. held for two hours at 190° C.;
5. temperature lowered from 190° C. to 30° C. at a rate of 2° C./min.

Curing condition 2:
1. temperature raised at a rate of 1.7° C./min from room temperature to 227° C.;
2. held for four hours at 227° C.;
3. temperature lowered from 227° C. to 30° C. at a rate of 2° C./min.

The experimental results are shown in Tables 1 and 2 for the working examples and in Tables 3 and 4 for the comparative examples. The thermosetting resin components (A) and (B) are provided as weight percent of the total of components (A), (B), (C), (D1), (D2), and (E). The component (C) is provided as the weight percent of the total of components (A), (B), (C), and (E), i.e., excluding the weight of the particles (D1) and (D2). The component (E) is provided as the weight percent of the weight of components (A) and (B). The particles (D1) and (D2) are shown as volume % of the total volume of thermosetting resin components (A), (B), (C), (DU, (D2), and (E).

TABLE 1
Working Examples 1-5

| | | Example 1 | Example 2 | Example 3 | Example 4 | Example 5 |
|---|---|---|---|---|---|---|
| | Carbon Fiber | Torayca ® | Torayca ® | Torayca ® | Torayca ® | Torayca ® |
| Component (A) | Compimide 353A | 62 | 60 | 61 | 61 | 60 |
| Component (B) | Compimide TM124 | 29 | 29 | 29 | 29 | 28 |
| Component (C) | Matrimid 9725 | 2 | 2 | 2 | 2 | 2 |
| Particles | P84 NT SF | 4.1 | 7.9 | 4.1 | 5.7 | 5.7 |
| (D1) and (D2) | (PI) - (D1) | | | | | |
| | P84 NT F | | | 3.7 | 2.4 | 3.6 |
| | (PI) - (D2) | | | | | |
| | iM30K (glass | 3.8 | 3.6 | | | |
| | bubbles) - (D2) | | | | | |
| Component (E) | Triphenyl | 0.1 | 0.1 | 0.1 | 0.1 | 0.1 |
| accelerator | phosphine | | | | | |
| Number of peaks observed (particles) | | 2 | 2 | 2 | 2 | 2 |
| Volume ratio (D1):(D2) | | 52:48 | 69:31 | 53:47 | 70:30 | 61:39 |
| Total volume % | | 7.9 | 10.5 | 7.8 | 8.1 | 9.3 |
| Tack level at 25° C. | | Medium | Low | Low | Low | Low |
| Tack level at 32° C. | | High | High | High | High | High |
| CAI | Postcure at | 42.3 | 44.0 | 45.9 | 51.6 | 45.0 |
| | 227° C. 4 hrs | | | | | |
| | sigma | 0.7 | 0.3 | 0.5 | 0.5 | 1.6 |
| | Damage area (cm²) | 12.9 | 10.3 | 9.7 | — | — |

TABLE 2
Working Examples 6-9

| | | Example | | | | | | | |
|---|---|---|---|---|---|---|---|---|---|
| | | 6 | 7 | 8 | 9 | 10 | 11 | 12 | 13 |
| | Carbon Fiber | Torayca ® | | | | | | | |
| Component (A) | Compimide 353A | 58 | 59 | 60 | 59 | 56 | 60 | 59 | 62 |
| Component (B) | Compimide TM124 | 27 | 28 | 28 | 28 | 26.4 | 28 | 28 | 29 |
| Component (C) | Matrimid 9725 | 2 | 2 | 2 | 2 | 2 | 2 | 2 | 0 |
| Particles | P84 NT SF | 7.9 | 8.0 | 8.0 | 8.0 | 12.1 | 8.1 | 4.7 | 5.8 |
| (D1) and (D2) | (PI) - (D1) | | | | | | | | |
| | P84 NT F | 3.5 | 2.4 | 1.6 | 2.4 | 2.3 | 1.0 | 6.0 | 2.5 |
| | (PI) - (D2) | | | | | | | | |
| | iM30K (glass | — | — | — | — | — | — | — | — |
| | bubbles) - (D2) | | | | | | | | |
| Accelerator | Triphenyl | 0.1 | 0.1 | 0.1 | 0.1 | 0.1 | 0.1 | 0.1 | 0 |
| Component (E) | phosphine | | | | | | | | |
| Number of peaks (particles) | | 2 | 2 | 2 | 2 | 2 | 2 | 2 | 2 |
| Volume ratio (D1):(D2) | | 69:31 | 77:23 | 83:17 | 77:23 | 84:16 | 89:11 | 44:56 | 70:30 |
| Total Volume % | | 11.4 | 10.4 | 9.6 | 10.4 | 14.4 | 9.1 | 10.7 | 8.3 |
| Tack level at 25° C. | | Low | Low | Low | Low | Low | Low | Low | Low |
| Tack level at 32° C. | | High | High | High | High | High | High | High | High |
| CAI | Postcure at | 46.6 | 54.8 | 48.5 | 47.3 | 48.4 | 48.9 | 43.6 | 51.5 |
| | 227° C. 4 hrs | | | | | | | | |
| | sigma | 0.7 | 0.9 | 1.5 | 1.5 | 1.2 | 2.4 | 1.8 | 2.7 |
| | Damage area (cm²) | 9.7 | 9.0 | 9.7 | | | | | |

TABLE 3
Comparative Examples 1-4

| | | Comp. | Comp. | Comp. | Comp. |
|---|---|---|---|---|---|
| | | Example 1 | Example 2 | Example 3 | Example 4 |
| | Carbon Fiber | Torayca ® | Torayca ® | Torayca ® | Torayca ® |
| Component (A) | Compimide | 67 | 67 | 64 | 64 |
| | 353A | | | | |
| Component (B) | Compimide | 31 | 31 | 30 | 30 |
| | TM124 | | | | |
| Component (C) | Matrimid | 2 | 2 | 2 | 2 |
| | 9725 | | | | |
| Particles (D1) | P84 NT SF | | | | |
| and (D2) | (PI) - (D1) | | | | |
| | P84 NT F | | | | |
| | (PI) - (D2) | | | | |
| | iM30K (glass | | | 7.5 | 7.5 |
| | bubbles) - (D2) | | | | |
| Accelerator | Triphenyl | 0.1 | 0.1 | 0.1 | 0.1 |
| Component (E) | phosphine | | | | |
| Number of peaks (particles) | | No | No | 1 | 1 |
| | | particles | particles | | |
| Volume ratio (D1):(D2) | | No | No | — | — |
| | | particles | particles | | |
| Total Volume % | | 0 | 0 | 7.5 | 7.5 |
| Tack level at 25° C. | | Med | Med | Med | Med |
| Tack level at 32° C. | | High | High | High | High |
| CAI | Postcure at | 27.2 | 24.9 | 26.4 | 28.9 |
| | 227° C. 4 hrs | | | | |
| | sigma | 0.9 | 0.9 | 0.7 | 1.2 |
| | Damage area (in²) | 13.6 | 20.0 | 18.1 | 13.6 |

TABLE 4
Comparative Examples 5-7

| | | Comp. | Comp. | Comp. | Comp. | Comp. | Comp. |
|---|---|---|---|---|---|---|---|
| | | Example 5 | Example 6 | Example 7 | Example 8 | Example 10 | Example 11 |
| | Carbon Fiber | Torayca | Torayca | Torayca ® | Torayca ® | Torayca ® | Torayca ® |
| Component (A) | Compimide 353A | 48 | 61 | 61 | 59 | 62 | 62 |
| Component (B) | Compimide TM124 | 23 | 29 | 29 | 28 | 29 | 29 |
| Component (C) | Matrimid 9725 | 2 | 2 | 2 | 2 | 2 | 2 |
| Component | P84 NT SF | 26.4 | 8.1 | — | 2.4 | 8.3 | |
| Particles | (PI) - (D1) | | | | | | |
| (D1) and (D2) | P84 NT F | — | — | 8.1 | 8 | | 8.3 |
| | (PI) - (D2) | | | | | | |
| | iM30K (glass | — | — | — | — | — | — |
| | bubbles) - (D2) | | | | | | |
| Accelerator | Triphenyl | 0.1 | 0.1 | 0.1 | 0.1 | 0.1 | 0.1 |
| Component (E) | phosphine | | | | | | |
| Number of peaks (particles) | | 1 | 1 | 1 | 2 | 1 | 1 |
| Volume ratio (D1):(D2) | | — | — | — | 23:77 | | |
| Total Volume % | | 26.4 | 8.1 | 8.1 | 10.4 | 8.3 | 8.3 |
| Tack level at 25° C. | | Low | Low | Low | Low | Low | Low |
| Tack level at 32° C. | | Low | High | Med | Med | Med | Med |
| CAI | Postcure at | 44.0 | 38.4 | 36.7 | 39.1 | 41.1 | 36.2 |
| | 227° C. 4 hrs | | | | | | |
| | sigma | — | — | | 2.1 | 2.1 | 3.1 |
| | Damage area (cm²) | — | — | — | — | — | — |

As can be seen from the above examples, the working examples 1 and 2 use the IM30K glass bubbles with an average particle size of 20 microns for the (D2) particle and the P84 SF particle for the (D1) particle. The results demonstrate that a higher relative amount of the (D2) particle combined with the (D1) particles exhibited an increase in the CAI compared to that of comparative examples 3 and 4 that used only the IM30K glass bubbles (D2) as particles for toughening. Surprisingly, a relatively small amount of the smaller (D1) particles were needed to effect a large change in the CAI values compared to the samples that do not include any (D1) particles at all.

Working examples 3-13 use different ratios and amounts of the (D1) and (D2) particles using the P84 particle for both (D1) and (D2). As can be seen from the CAI values, all are greater than 42 ksi giving them excellent toughness. Working example 13 does not have thermoplastic or accelerator, demonstrating that the combination of (D1) and (D2) particles provides toughening even with a high flow resin system, which is traditionally more difficult to toughen.

Example 12, even though it is slightly away from the 50:50 ratio, exhibits a CAI that is still high but not as high as the other working examples.

Comparative examples 3-7 and 10-11 use a single particle for toughening. Notably, these examples have a lower CAI value even though they incorporate a similar loading to the working examples where the two particle size distributions are used.

Comparative examples 1-2 do not include any particles. These samples demonstrate the CAI for this resin system with no particles added.

Comparative example 5 shows good CAI but at the expense of using a very large amount of the (D1) P84 SF particle. This large amount of (D1) particle made the sample very difficult to process and higher than normal temperatures were needed to properly mix and film the prepregs. The higher temperatures shortened the processing times due to the increased reactivity at these temperatures. Furthermore, the resulting prepreg had little to no tack. This material could still be made into a cured CFRP part but would not be practical as a commercial product.

Since larger particles create a better crack arrest and the smaller particles are thought to allow for better packing, it was surprising to find that only small amounts of the larger (D2) particles with a majority of the smaller particles (D1) provided better fracture toughness than using only (D2) particles or larger amounts of the larger (D2) particles, despite contrary expectations based on teachings of fracture mechanics. Furthermore, it was even more surprising to achieve such a high CAI result with the bimodal distribution of particle sizes compared to using a singles distribution of either larger particles such as the (D2) particles and or just smaller particles such as the (D1) particles.

1. A fiber reinforced prepreg comprising reinforcement fibers and a thermosetting resin composition comprising:
a first co-monomer (A),
a second co-monomer (B), and
particles (D);
wherein the particles (D) are insoluble in the first co-monomer (A) and the second co-monomer (B) and the particles (D) comprise from 4 to 18 percent by volume of the total thermosetting resin composition in the prepreg and have a range of particle diameters from 1 to 100 microns and at least one mode on a volume basis from 3 to 60 microns; and
wherein conditions i) and ii) are met:
i) the first co-monomer (A) comprises a maleimide compound and the second co-monomer (B) comprises at least one of an alkenylphenol group, an alkenylphenoxy group, or a diamine group; or
ii) the particles (D) comprise particles (D1), from 3 to 12 percent by volume of the total thermosetting resin composition in the prepreg, having a range of particle diameters from 1 to 10 microns and a mode on a volume basis from 3 to 6 microns; and particles (D2), from 1 to 6 percent by volume of the total thermosetting resin composition in the prepreg, having a range of particle diameters from 10 to 100 microns and a mode on a volume basis from 20 to 60 microns.

2. The fiber reinforced prepreg of claim 1, wherein a cured composite made from the fiber reinforced prepreg has a compressive strength after impact (CAI) of 35 ksi or more measured according to ASTM D7137M-17 after being impacted at 4.45 kJ/m when conditions i) and ii) are met.

3. The fiber reinforced prepreg of claim 1, wherein the prepreg comprises a fiber layer and an interlayer, and:
the fiber layer comprises the reinforcement fibers impregnated with the thermosetting resin composition, and
the interlayer comprises the thermosetting resin composition, the particles (D); and
wherein at least 90% by volume of the particles (D) remain in the interlayer after cure of the prepreg.

4. The fiber reinforced prepreg of claim 1, wherein the particles (D1) comprise from 5 to 10% by volume of the total volume of the thermosetting resin composition.

5. The fiber reinforced prepreg of claim 1, wherein the particles (D2) comprise from 2 to 4.5% of the total volume of thermosetting resin composition.

6. The fiber reinforced prepreg of claim 1, wherein a volume ratio of the particles (D1) to the particles (D2) is from 90:10 to 50:50, preferably from 80:20 to 40:60.

7. The fiber reinforced prepreg of claim 1, wherein the particles (D) comprise polyimide particles.

8. The fiber reinforced prepreg of claim 1, wherein the particles (D2) have a range of particle diameters of from 20 to 60 microns and a mode on a volume basis of from 20 to 50 microns.

9. The fiber reinforced prepreg of claim 1, wherein the particles (D) have a glass transition temperature of 200° C. or higher, preferably 220° C. or higher.

10. The fiber reinforced prepreg of claim 1, wherein the thermosetting resin composition further comprises a thermoplastic (C) dissolved therein.

11. The fiber reinforced prepreg of claim 10, wherein the thermoplastic (C) comprises polyimide and is present in an amount from 0.5 to 5% by weight of the total thermosetting resin composition, exclusive of the weight of particles (D1) and (D2).

12. The fiber reinforced prepreg of claim 1, wherein the thermosetting resin composition further comprises an accelerator in an amount sufficient to reduce the resin flow index of the thermosetting resin composition to 5 or less.

13. The fiber reinforced prepreg of claim 12, wherein the amount of accelerator is from 0.05 to 0.5% by weight of components (A) and (B).

14. The fiber reinforced prepreg of claim 12, wherein the accelerator comprises a phosphorous-containing accelerator.

15. The fiber reinforced prepreg of claim 1, wherein the maleimide compound (A) comprises at least one of N,N′-4,4′-diphenylmethane-bis-maleimide, N,N′-2,4-toluene-bis-maleimide, N,N′-2,2,4-trimethylhexane-bis-maleimide, or mixtures thereof.

16. The fiber reinforced prepreg of claim 1, wherein the maleimide compound (A) comprises a eutectic mixture of two or more bismaleimide compounds.

17. The fiber reinforced prepreg of claim 1, wherein the co-monomer (B) comprises o,o′-diallylbisphenol A.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. A method of making a thermosetting resin composition, the method comprising combining:
a first co-monomer (A),
a second co-monomer (B),
particles (D1), and
particles (D2);
wherein the particles (D1) and (D2) are insoluble in the first co-monomer (A) and the second co-monomer (B) and the particles (D1) have a range of particle diameters from 1 to 10 microns and a mode on a volume basis from 3 to 6 microns, and the particles (D1) comprise from 3 to 12 percent by volume of the total thermosetting resin composition; and the particles (D2) have a range of particle diameters from 10 to 100 microns and a mode on a volume basis from 20 to 60 microns and the particles (D2) comprise from 1 to 6 percent by volume of the total thermosetting resin composition.

31. The method of claim 30, wherein the first co-monomer (A) and the second co-monomer (B) are combined to form a monomer mixture and then the particles (D1) and (D2) are combined with the monomer mixture to form the thermosetting resin composition.

32. The method of claim 31, wherein the particles (D1) and the particles (D2) are combined to form a particle mixture and the particle mixture comprises two or more modes, and wherein the particle mixture is then combined with the monomer mixture to form the thermosetting resin composition.

33. The method of claim 30, wherein the particles (D1) and the particles (D2) are combined to form a particle mixture and the particle mixture comprises two or more modes.

34. The method of claim 33, wherein the particle mixture is combined with either the first co-monomer (A) or the second co-monomer (B) and then subsequently combined with the other of co-monomer (A) or co-monomer (B) to form the thermosetting resin.
